(19) United States
(12) Patent Application Publication
(10) Pub. No.: US 2017/0238232 A1
(43) Pub. Date: Aug. 17, 2017

(54) TRANSMIT ERROR VECTOR MAGNITUDE AND SPECTRAL MASK REQUIREMENTS FOR OFDMA TRANSMISSION

(71) Applicant: QUALCOMM Incorporated, San Diego, CA (US)

(72) Inventors: Lin YANG, San Diego, CA (US); Bin TIAN, San Diego, CA (US); Youhan KIM, San Jose, CA (US)

(21) Appl. No.: 15/434,901

(22) Filed: Feb. 16, 2017

Related U.S. Application Data
(60) Provisional application No. 62/296,539, filed on Feb. 17, 2016.
(60) Provisional application No. 62/365,350, filed on Jul. 21, 2016.

(51) Int. Cl. H04W 40/02; H04L 5/00; H04W 72/04; H04W 28/20; H04L 1/00; H04W 52/22

(52) U.S. Cl. CPC H04W 40/02; H04L 1/0015; H04W 52/22; H04W 72/044; H04W 28/20; H04L 5/0007; H04L 5/0073

(57) ABSTRACT

A method, an apparatus, and a computer-readable medium for wireless communication are provided. In one aspect, an apparatus is configured to determine an RU allocated to the apparatus within a communication bandwidth for OFDMA transmission. The apparatus is configured to transmit a data packet on the allocated RU based on requirements associated with an amount of inter-RU interference to other RUs allocated to other wireless devices. In an aspect, the requirements may include at least one of an error vector magnitude (EVM) requirement or a spectral mask requirement.

### CROSS-REFERENCE TO RELATED APPLICATION(S)

This application claims the benefit of U.S. Provisional Application Ser. No. 62/296,539, entitled “TXEVM AND SPECTRAL MASK REQUIREMENTS FOR OFDMA TRANSMISSION” and filed on Feb. 17, 2016 and U.S. Provisional Application Ser. No. 62/365,350, entitled “TXEVM AND SPECTRAL MASK REQUIREMENTS FOR OFDMA TRANSMISSION” and filed on Jul. 21, 2016, which are expressly incorporated by reference herein in their entirety.

### BACKGROUND

Field

The present disclosure relates generally to communication systems, and more particularly, to transmitter (TX) error vector magnitude (EVM) (TXEVM) requirements and spectral mask requirements for orthogonal frequency-division multiple access (OFDMA) transmission.

Background

In many telecommunication systems, communications networks are used to exchange messages among several interacting spatially-separated devices. Networks may be classified according to geographic scope, which could be, for example, a metropolitan area, a local area, or a personal area. Such networks would be designated respectively as a wide area network (WAN), metropolitan area network (MAN), local area network (LAN), wireless local area network (WLAN), or personal area network (PAN). Networks also differ according to the switching/routing technique used to interconnect the various network nodes and devices (e.g., circuit switching vs. packet switching), the type of physical media employed for transmission (e.g., wired vs. wireless), and the set of communication protocols used (e.g., Internet protocol suite, Synchronous Optical Networking (SONET), Ethernet, etc.).

Wireless networks are often preferred when the network elements are mobile and thus have dynamic connectivity needs, or if the network architecture is formed in an ad hoc, rather than fixed, topology. Wireless networks employ intangible physical media in an unguided propagation mode using electromagnetic waves in the radio, microwave, infra-red, optical, etc., frequency bands. Wireless networks advantageously facilitate user mobility and rapid field deployment when compared to fixed wired networks.

### SUMMARY

The systems, methods, computer-readable media, and devices of the invention each have several aspects, no single one of which is solely responsible for the invention's desirable attributes. Without limiting the scope of this invention as expressed by the claims which follow, some features will now be discussed briefly. After considering this discussion, and particularly after reading the section entitled “Detailed Description,” one will understand how the features of this invention provide advantages for devices in a wireless network.

One aspect of this disclosure provides a wireless device (e.g., a station) for wireless communication. The wireless device is configured to determine an RU allocated to the wireless device within a communication bandwidth for OFDMA transmission. The wireless device is configured to transmit a data packet on the allocated RU based on requirements associated with an amount of inter-RU interference to other RUs allocated to other wireless devices. In an aspect, the requirements may include at least one of an error vector magnitude (EVM) requirement or a spectral mask requirement.

In another aspect, a method for wireless communication is provided. The method may include determining an RU allocated to the wireless device within a communication bandwidth for OFDMA transmission. The method may include transmitting a data packet on the allocated RU based on requirements associated with an amount of inter-RU interference to other RUs allocated to other wireless devices, the requirements including at least one of an EVM requirement or a spectral mask requirement

In another aspect, a wireless device (e.g., a station) for wireless communication is provided. The wireless device may include means for determining an RU allocated to the wireless device within a communication bandwidth for OFDMA transmission. The wireless device may include means for transmitting a data packet on the allocated RU based on requirements associated with an amount of inter-RU interference to other RUs allocated to other wireless devices, the requirements including at least one of an EVM requirement or a spectral mask requirement.

In another aspect, an wireless device (e.g., a station) for wireless communication is provided. The wireless device may include memory and at least one processor coupled to the memory. The at least one processor may be configured to: determine an RU allocated to the wireless device within a communication bandwidth for OFDMA transmission, and transmit a data packet on the allocated RU based on requirements associated with an amount of inter-RU interference to other RUs allocated to other wireless devices, the requirements including at least one of an EVM requirement or a spectral mask requirement.

In another aspect, a computer-readable medium of a wireless device storing computer executable code. The computer-readable medium may include code to: determine an RU allocated to the wireless device within a communication bandwidth for OFDMA transmission, and transmit a data packet on the allocated RU based on requirements associated with an amount of inter-RU interference to other RUs allocated to other wireless devices, the requirements including at least one of an EVM requirement or a spectral mask requirement.

### BRIEF DESCRIPTION OF THE DRAWINGS

FIG. 1 shows an example wireless communication system in which aspects of the present disclosure may be employed.

FIG. 2 is an exemplary diagram of a wireless network.

FIG. 3 illustrates an exemplary resource unit configuration for a 20 MHz symbol.

FIG. 4 is a constellation diagram that illustrates TXEVM measurements.

FIG. 5 is an exemplary diagram illustrating a spectral mask for a 20 MHz communication band.

FIG. 6 is an exemplary diagram of a method for UL OFDMA transmission.

FIG. 7 is a graph that illustrates signal and interference levels with ideal power control.

FIG. 8 is a graph that illustrates signal and interference levels when a power at the receiver is the same for all modulation coding schemes (MCSs) after power control.

FIG. 9 is a graph illustrating a data packet transmission within the boundaries of a 20 MHz spectral mask.

FIG. 10 is a functional block diagram of a wireless device that may be employed within the wireless communication system of FIG. 1 for OFDMA transmission.

FIG. 11 is a flowchart of an exemplary method of OFDMA transmission.

FIG. 12 is a functional block diagram of an exemplary wireless communication device for OFDMA transmission.

### DETAILED DESCRIPTION

Various aspects of the novel systems, apparatuses, computer-readable media, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, computer program products, and methods disclosed herein, whether implemented independently of, or combined with, any other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Popular wireless network technologies may include various types of WLANs. A WLAN may be used to interconnect nearby devices together, employing widely used networking protocols. The various aspects described herein may apply to any communication standard, such as a wireless protocol.

In some aspects, wireless signals may be transmitted according to an 802.11 protocol using orthogonal frequency-division multiplexing (OFDM), direct-sequence spread spectrum (DSSS) communications, a combination of OFDM and DSSS communications, or other schemes. Implementations of the 802.11 protocol may be used for sensors, metering, and smart grid networks. Advantageously, aspects of certain devices implementing the 802.11 protocol may consume less power than devices implementing other wireless protocols, and/or may be used to transmit wireless signals across a relatively long range, for example about one kilometer or longer.

In some implementations, a WLAN includes various devices which are the components that access the wireless network. For example, there may be two types of devices: access points (APs) and clients (also referred to as stations or “STAs”). In general, an AP may serve as a hub or base station for the WLAN and a STA serves as a user of the WLAN. For example, a STA may be a laptop computer, a personal digital assistant (PDA), a mobile phone, etc. In an example, a STA connects to an AP via a Wi-Fi (e.g., IEEE 802.11 protocol) compliant wireless link to obtain general connectivity to the Internet or to other wide area networks. In some implementations a STA may also be used as an AP.

An access point may also comprise, be implemented as, or known as a NodeB, Radio Network Controller (RNC), eNodeB, Base Station Controller (BSC), Base Transceiver Station (BTS), Base Station (BS), Transceiver Function (TF), Radio Router, Radio Transceiver, connection point, or some other terminology.

A STA may also comprise, be implemented as, or known as an access terminal (AT), a subscriber station, a subscriber unit, a mobile station, a remote station, a remote terminal, a user terminal, a user agent, a user device, a user equipment, or some other terminology. In some implementations, a STA may comprise a cellular telephone, a cordless telephone, a Session Initiation Protocol (SIP) phone, a wireless local loop (WLL) station, a personal digital assistant (PDA), a handheld device having wireless connection capability, or some other suitable processing device connected to a wireless modem. Accordingly, one or more aspects taught herein may be incorporated into a phone (e.g., a cellular phone or smartphone), a computer (e.g., a laptop), a portable communication device, a headset, a portable computing device (e.g., a personal data assistant), an entertainment device (e.g., a music or video device, or a satellite radio), a gaming device or system, a global positioning system device, or any other suitable device that is configured to communicate via a wireless medium.

In an aspect, MIMO schemes may be used for wide area WLAN (e.g., Wi-Fi) connectivity. MIMO exploits a radio-wave characteristic called multipath. In multipath, transmitted data may bounce off objects (e.g., walls, doors, furniture), reaching the receiving antenna multiple times through different routes and at different times. A WLAN device that employs MIMO will split a data stream into multiple parts, called spatial streams, and transmit each spatial stream through separate antennas to corresponding antennas on a receiving WLAN device.

The term “associate,” or “association,” or any variant thereof should be given the broadest meaning possible within the context of the present disclosure. By way of example, when a first apparatus associates with a second apparatus, it should be understood that the two apparatuses may be directly associated or intermediate apparatuses may be present. For purposes of brevity, the process for establishing an association between two apparatuses will be described using a handshake protocol that requires an “association request” by one of the apparatus followed by an “association response” by the other apparatus. It will be understood by those skilled in the art that the handshake protocol may require other signaling, such as by way of example, signaling to provide authentication.

Any reference to an element herein using a designation such as “first,” “second,” and so forth does not generally limit the quantity or order of those elements. Rather, these designations are used herein as a convenient method of distinguishing between two or more elements or instances of an element. Thus, a reference to first and second elements does not mean that only two elements can be employed, or that the first element must precede the second element. In addition, a phrase referring to “at least one of” a list of items refers to any combination of those items, including single members. As an example, “at least one of: A, B, or C” is intended to cover: A, or B, or C, or any combination thereof (e.g., A-B, A-C, B-C, and A-B-C).

As discussed above, certain devices described herein may implement the 802.11 standard, for example. Such devices, whether used as a STA or AP or other device, may be used for smart metering or in a smart grid network. Such devices may provide sensor applications or be used in home automation. The devices may instead or in addition be used in a healthcare context, for example for personal healthcare. They may also be used for surveillance, to enable extended-range Internet connectivity (e.g. for use with hotspots), or to implement machine-to-machine communications.

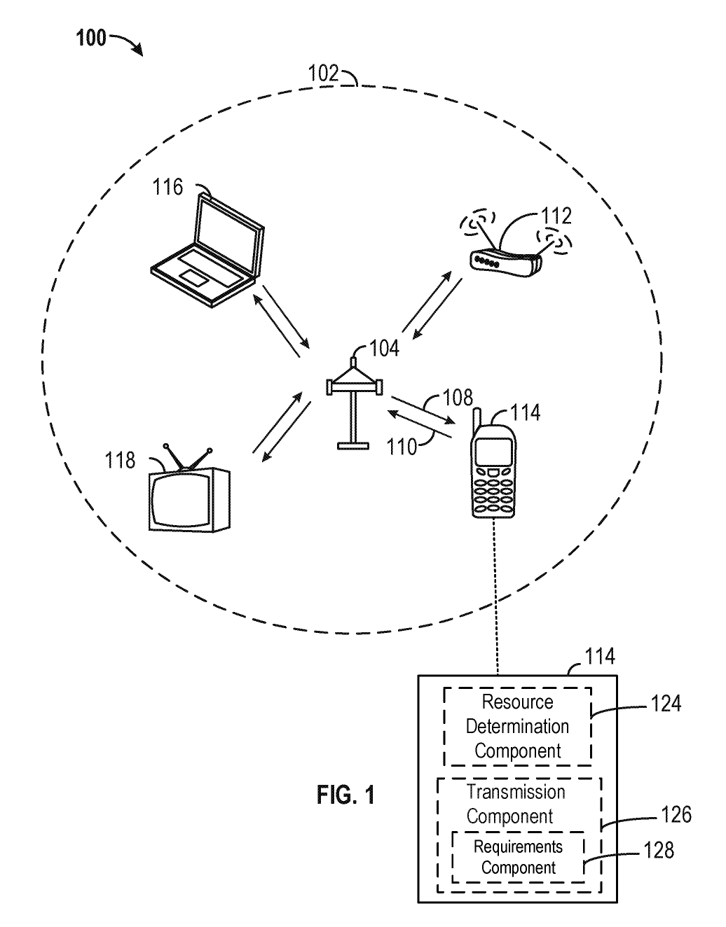

FIG. 1 shows an example wireless communication system 100 in which aspects of the present disclosure may be employed. The wireless communication system 100 may operate pursuant to a wireless standard, for example the 802.11 standard. The wireless communication system 100 may include an AP 104, which communicates with STAs (e.g., STAs 112, 114, 116, and 118).

A variety of processes and methods may be used for transmissions in the wireless communication system 100 between the AP 104 and the STAs. For example, signals may be sent and received between the AP 104 and the STAs in accordance with OFDM/OFDMA techniques. If this is the case, the wireless communication system 100 may be referred to as an OFDM/OFDMA system. Alternatively, signals may be sent and received between the AP 104 and the STAs in accordance with CDMA techniques. If this is the case, the wireless communication system 100 may be referred to as a CDMA system.

A communication link that facilitates transmission from the AP 104 to one or more of the STAs may be referred to as a downlink (DL) 108, and a communication link that facilitates transmission from one or more of the STAs to the AP 104 may be referred to as an uplink (UL) 110. Alternatively, a downlink 108 may be referred to as a forward link or a forward channel, and an uplink 110 may be referred to as a reverse link or a reverse channel. In some aspects, DL communications may include unicast or multicast traffic indications.

The AP 104 may suppress adjacent channel interference (ACI) in some aspects so that the AP 104 may receive UL communications on more than one channel simultaneously without causing significant analog-to-digital conversion (ADC) clipping noise. The AP 104 may improve suppression of ACI, for example, by having separate finite impulse response (FIR) filters for each channel or having a longer ADC backoff period with increased bit widths.

The AP 104 may act as a base station and provide wireless communication coverage in a basic service area (BSA) 102. A BSA (e.g., the BSA 102) is the coverage area of an AP (e.g., the AP 104). The AP 104 along with the STAs associated with the AP 104 and that use the AP 104 for communication may be referred to as a basic service set (BSS). It should be noted that the wireless communication system 100 may not have a central AP (e.g., AP 104), but rather may function as a peer-to-peer network between the STAs. Accordingly, the functions of the AP 104 described herein may alternatively be performed by one or more of the STAs.

The AP 104 may transmit on one or more channels (e.g., multiple narrowband channels, each channel including a frequency bandwidth) a beacon signal (or simply a “beacon”), via a communication link such as the downlink 108, to other nodes (STAs) of the wireless communication system 100, which may help the other nodes (STAs) to synchronize their timing with the AP 104, or which may provide other information or functionality. Such beacons may be transmitted periodically. In one aspect, the period between successive transmissions may be referred to as a superframe. Transmission of a beacon may be divided into a number of groups or intervals. In one aspect, the beacon may include, but is not limited to, such information as timestamp information to set a common clock, a peer-to-peer network identifier, a device identifier, capability information, a superframe duration, transmission direction information, reception direction information, a neighbor list, and/or an extended neighbor list, some of which are described in additional detail below. Thus, a beacon may include information that is both common (e.g., shared) amongst several devices and specific to a given device.

In some aspects, a STA (e.g., STA 114) may be required to associate with the AP 104 in order to send communications to and/or to receive communications from the AP 104. In one aspect, information for associating is included in a beacon broadcast by the AP 104. To receive such a beacon, the STA 114 may, for example, perform a broad coverage search over a coverage region. A search may also be performed by the STA 114 by sweeping a coverage region in a lighthouse fashion, for example. After receiving the information for associating, the STA 114 may transmit a reference signal, such as an association probe or request, to the AP 104. In some aspects, the AP 104 may use backhaul services, for example, to communicate with a larger network, such as the Internet or a public switched telephone network (PSTN).

In an aspect, the STA 114 may include one or more components (or circuits) for performing various functions. For example, the STA 114 may include a resource determination component 124 and a transmission component 126 with a requirements component 128 that are configured to perform procedures related to meeting inter-RU interference requirements. In this example, the resource determination component 124 may be configured to determine an RU allocated to the apparatus within a communication bandwidth for OFDMA transmission. In an aspect, the resource determination component 124 may be configured to receive, from the AP 104, RU allocation information indicating an RU allocated to the STA 114 within a communication bandwidth for OFDMA transmission, where the resource determination component 124 may determine the allocated RU based on the RU allocation information. The transmission component 126 may be configured to transmit a data packet on the allocated RU based on requirements (e.g., specified by the requirements component 128) associated with an amount of inter-RU interference to other RUs allocated to other wireless devices. In an aspect, the transmission component 126 may be configured to select an MCS to be used for the transmission on the allocated RU, and to set a transmit power for the transmission based on the EVM requirement on the allocated RU for the selected MCS, where the data packet is transmitted on the allocated RU using the set transmit power. In an aspect, the transmission component 126 may be configured to perform at least one of: setting a transmit power for the transmission based on the spectral mask requirement, where the data packet is transmitted on the allocated RU using the set transmit power, or filtering a signal carrying the data packet with a filter based on at least one of the spectral mask requirement, where the data packet is transmitted on the allocated RU by transmitting the filtered signal.

In Wi-Fi networks, data may be communicated in a data packet (also referred to as a frame) over a wireless medium using a waveform that may be modulated over a fixed frequency band during a fixed period of time. The frequency band may be divided into groups of one or more tones, and the period of time may be divided into one or more symbols. As an example, a 20 megahertz (MHz) frequency band may be divided in four 5 MHz tones (or another number of tones) and an 80 microsecond period may be divided into twenty 4 microsecond symbols (or another number of symbols with different symbol durations). Accordingly, a “tone” may represent a frequency sub-band. A tone may alternatively be referred to as a subcarrier. A tone may thus be a unit of frequency. A symbol may be a unit of time representing a duration of time. Thus, the waveform for the packet may be visualized as a two-dimensional structure that includes one or more tones (often on a vertical axis in units of frequency) and one or more symbols (often on a horizontal axis in units of time).

Each symbol may include a number of tones (or frequencies or subcarriers) on which information may be transmitted. A symbol also has symbol duration (e.g. 1×, 2×, 4× symbol duration). Symbols with longer symbol duration (e.g., 4× symbol duration) may have more tones and a longer time duration, and symbols with shorter symbol duration (e.g. lx symbol duration) may have less tones and a shorter time duration. For example, in a first symbol with a 4× symbol duration, the first symbol may be four times longer in time than a second symbol with a 1× symbol duration. The first symbol may have four times as many tones as the second symbol with a 1× symbol duration. The first symbol may have one-fourth of the tone spacing compared to a second symbol with 1× symbol duration.

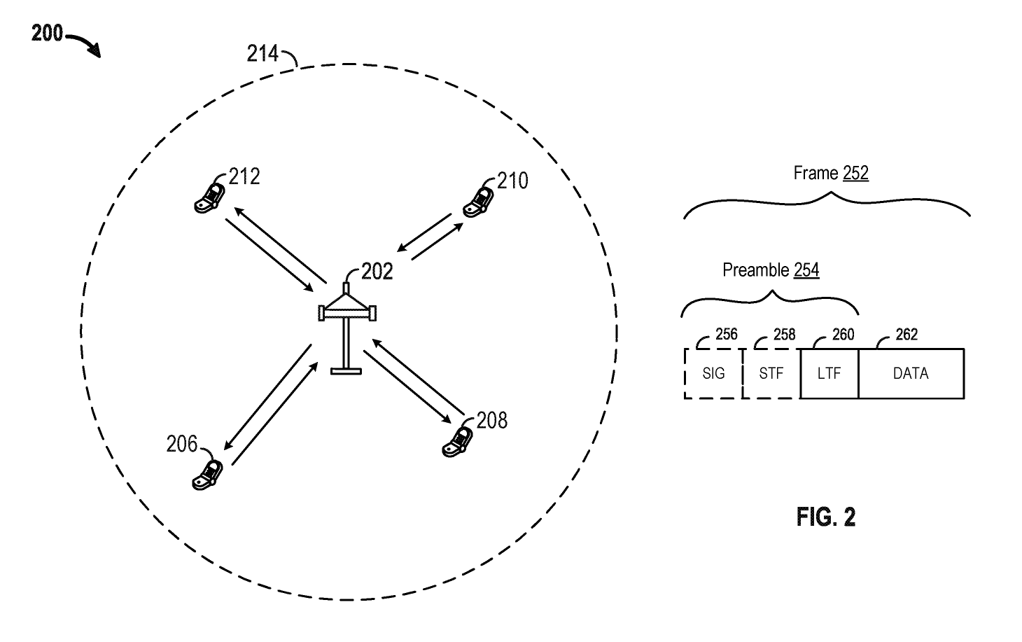

FIG. 2 is an exemplary diagram 200 of a wireless network. The diagram 200 illustrates an AP 202 broadcasting/transmitting within a service area 214. STAs 206, 208, 210, 212 are within the service area 214 of the AP 202 (although only four STAs are shown in FIG. 2, more or less STAs may be within the service area 214).

Referring to FIG. 2, the STA 206, for example, may transmit packets to the AP 202 in the form of a frame 252 and vice versa. The frame 252 may include a preamble 254 and data symbols 262. The preamble 254 may be considered a header of the frame 252 with information identifying a modulation scheme, a transmission rate, and a length of time to transmit the frame 252. The preamble 254 may include a signal (SIG) field 256, a short training field (STF) 258, and one or more long training field (LTF) symbols 260 (e.g., LTF1, LTF2, . . . , LTFN). The SIG field 256 may be used to transfer rate and length information. The STF 258 may be used to improve automatic gain control (AGC) in a multi-transmit and multi-receive system. The LTF symbols 260 may provide the information needed for a receiver (e.g., the AP 202) to perform channel estimation.

In an aspect, the AP 202 may assign resources to the STAs 206, 208, 210, 212 for uplink OFDMA transmission. The resources may include one or more resource units (RUs) within a communication bandwidth (e.g., a 20 MHz, 40 MHz, 80 MHz, 160 MHz bandwidth). Each RU may include a group or a set of usable tones (e.g., 26 usable tones, 52 usable tones, 106 usable tones, 242 usable tones, etc.) within an OFDM symbol. A usable tone may be a tone suitable for transmitting data or pilot signals and is not a guard tone or a direct current (DC) tone. In an aspect, a communication bandwidth may have multiple RUs depending on the size of the communication bandwidth and the size of each RU within the communication bandwidth. In some instances, a communication bandwidth, such as a 20 MHz bandwidth, may have four 52-tone RUs, and each 52-tone RU may be assigned to a respective one of the STAs 206, 208, 210, 212 for uplink OFDMA transmission.

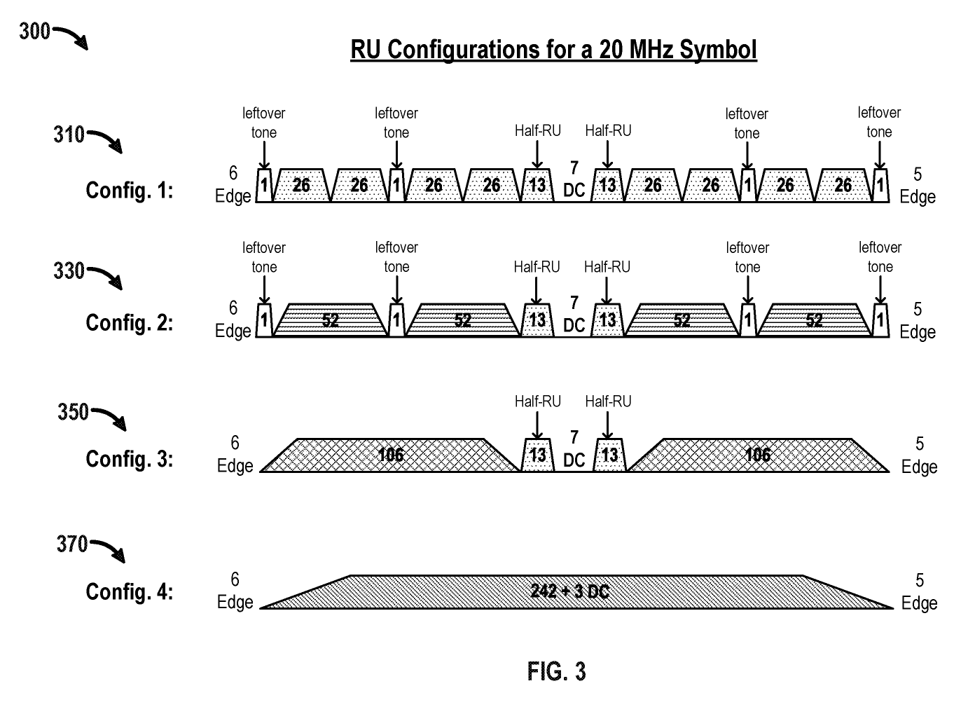

FIG. 3 illustrates exemplary resource unit configurations 300 for a 20 MHz symbol. In an aspect, the 20 MHz symbol may be a data symbol with a 4× symbol duration. Referring to FIG. 3, four different RU configurations (e.g., configuration 1 with 26-tone RUs, configuration 2 with 52-tone RUs, configuration 3 with 106-tone RUs, configuration 4 with a 242-tone RU) for the 20 MHz symbol are provided. Other RU configurations may also be used. In the first (or top) row 310 showing configuration 1, a number of 26-tone RUs, specifically nine 26-tone RUs, are provided. In the middle of the first row 310, one of the 26-tone RUs may be split into two half-RUs located around the 7 DC tones, where each half-RU may have 13 tones. There are 6 edge or guard tones at the left end of the first row 310 and 5 edge tones at the right end of the first row 310. Dispersed in between some of the RUs may be “leftover” tones, which may consist of 1 tone. In the first row 310, four leftover tones are provided. In an aspect, leftover tones may not have any energy.

In the second row 330 showing configuration 2, a number of RUs, specifically 5 RUs including four 52-tone RUs and one 26-tone RU, are provided. In the middle of the second row 330, the 26-tone RU may be split into two half-RUs located around the 7 DC tones, where each half-RU may have 13 tones. There are 6 edge or guard tones at the left end of the second row 330 and 5 edge tones at the right end of the second row 330. Dispersed in between some of the RUs may be leftover tones, which may consist of 1 tone. In the second row 330, four leftover tones are provided. In this row, 4 RUs may have 52 usable tones and the middle RU may have 26 usable tones.

In the third row 350 showing configuration 3, a number of RUs, specifically 3 RUs including two 106-tone RUs and one 26-tone RU, are provided. In the third row 350, 2 RUs may have 106 usable tones and the middle RU may have 26 usable tones. In the middle of the third row 350, the 26-tone RU may be split into two half-RUs located around the 7 DC tones, and each half-RU may have 13 tones. There are 6 edge or guard tones at the left end of the third row 350 and 5 edge tones at the right end of the third row 350. In the third row 350, no leftover tones are provided.

In the fourth row 370 showing the fourth configuration, a single RU (e.g., a 242-tone RU) is provided. In the fourth row 370, 3 DC tones may be located in the middle of the RU, and the RU may have 242 usable tones.

Although FIG. 3 illustrates an exemplary RU configuration for a 20 MHz symbol, other RU configurations in symbols having different communication bandwidths (e.g., 40 MHz, 80 MHz, or 160 MHz symbol) may also be used.

Referring to FIG. 2, by way of example, according to the second configuration in the second row 330, the STA 206 may be assigned the first 52-tone RU (starting from the left), the STA 208 may be assigned the second 52-tone RU, the STA 210 may be assigned the third 52-tone RU, and the STA 212 may be assigned the fourth 52-tone RU. In this example, inter-user interference between the STAs may result when each of the STAs 206, 208, 210, 212 engage in UL OFDMA transmission using the assigned RUs. That is, narrow band transmission (e.g., within an RU) by one STA may cause inter-RU interference to other STAs. To reduce such inter-RU interference, transmission waveform requirements, such as TXEVM and spectral mask requirements, may be tailored for UL OFDMA transmission.

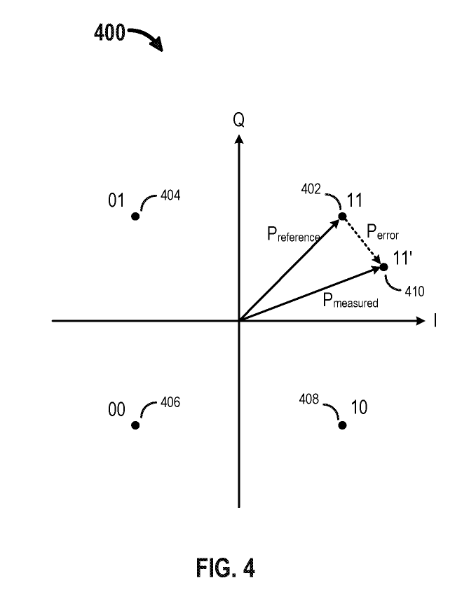

FIG. 4 is a constellation diagram 400 that illustrates TXEVM measurements. The TXEVM may be a measurement used to quantify the performance of a wireless transmitter. In an aspect, a signal transmitted by an ideal transmitter would have all constellation points 00, 01, 10, 11 at the ideal locations 402, 404, 406, 408 on the I-Q plane. However, transmitter imperfections may cause the actual constellation points to deviate from the ideal locations. The EVM may be a measure of how far the actual points are from the ideal locations. For example, in FIG. 4, the ideal location for the constellation point 11 may be at 402, but the actual transmitted location may be at 410 for the transmitted constellation point 11′. Thus, the EVM may be determined based on a difference between the ideal location for the constellation point 11 at 402 and the transmitted constellation point 11′ at 410. The distortion in the transmitted signal, as measured by the EVM value, may be due to impairments at a wireless transmitter due to power amplifier non-linearities, phase noise, and/or I-Q imbalance.

Referring to FIG. 4, the P error vector may be an error vector that corresponds to the difference between the actual received symbols and the ideal symbols. Pₑᵣᵣₒᵣ may correspond to the root mean square (RMS) power of the error vector, the P_{reference} vector may correspond to the reference constellation average power for the ideal location, and P_{measured} vector may correspond to the actual measured power of the actual transmitted location. Thus, Pₑᵣᵣₒᵣ vector may be a difference between P_{reference} vector and P_{measured} vector. Based on these values, TXEVM may be conceptually based on Eq. 1:

$$TXEVM ( dB ) = 10 {log}_{10} ( \frac{{P}_{error}}{{P}_{reference}} ) . \qquad ( 1 )$$

The EVM may be tailored for OFDMA transmissions. In a first option, the OFDMA transmission may need to comply with per RU in-band EVM requirements. That is, an OFDMA transmission may need to satisfy in-band RU EVM requirements associated with the RU on which the data is to be transmitted as opposed to only complying with the EVM requirements over an entire bandwidth.

In a second option, the OFDMA transmission may need to satisfy an EVM on the whole communication bandwidth, and the EVM may be measured by providing data on the in-band RU and by not transmitting anything on the tones outside of the RU. In other words, the tones outside of the RU have zero transmission of data. To determine the EVM of the communication bandwidth for a symbol (e.g., an OFDM symbol), the symbol may be transformed into subcarrier received values. For each value on a data-carrying subcarrier, a closest constellation point may be identified, and a Euclidean distance may be computed between the value and the closest constellation point. The EVM of the communication bandwidth may be based on the errors in the allocated RU averaged over the entire bandwidth. The in-band RU EVM may be based on the errors in the allocated RU averaged within the allocated RU.

At least two requirements may be considered with regard to the inter-user/inter-RU interference issues, such as an EVM requirement and a spectral mask requirement. According to the EVM requirement, EVM may be used for measuring non-orthogonal interference affecting demodulation performance. Measurement of non-orthogonal interference is relevant because in an OFDM operation, a Fast-Fourier Transform (FFT) operation may be performed on the signal to be transmitted. In particular, performing the FFT operation may result leakage to other tones outside of the RU, which causes an FFT-induced interference. Typically, the FFT-induced interference is orthogonal to the signal transmitted in other RUs. However, if the signal is distorted, then the FFT-induced interference may become non-orthogonal interference, which could affect the performance of the adjacent RUs. In an aspect, the TXEVM may be used for controlling the inter-RU interference impact to an OFDMA receiver.

Aside from the EVM requirement, spectral mask requirements may also be extended for OFDMA transmission to limit the adjacent channel interference to other systems. The spectral mask may be used to measure the total out-of-band transmission power, which may include orthogonal and non-orthogonal interferences. Previously, before the OFDMA was introduced, the spectral mask was defined to cover an entire bandwidth to limit the adjacent channel interference between different (or overlapping) basic service sets. For non-synchronous systems, out-of-band transmissions result in adjacent channel interference to other basic service sets. For example, if two systems are not synchronized in frequency (e.g., one system operates in the 20 MHz band and the other system operates in the 40 MHz band), then the interference is non-orthogonal even with an ideal transmitter. However, with OFDMA, the spectral mask may be further tailored to OFDMA transmissions to limit such interference for non-synchronized systems.

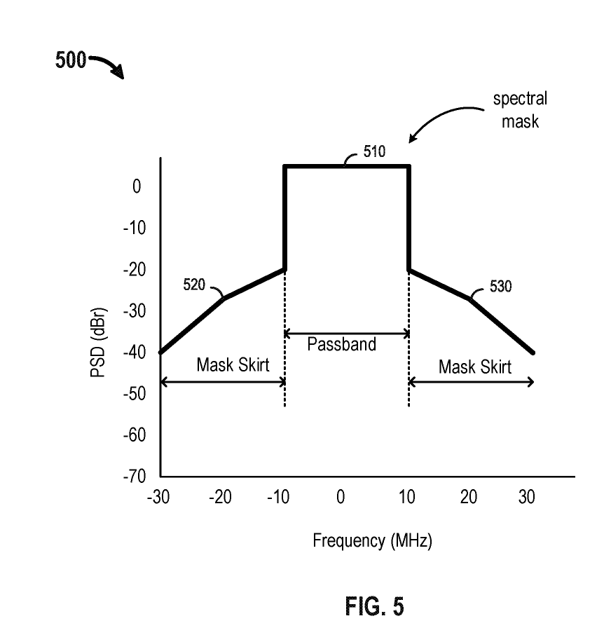

FIG. 5 is an exemplary diagram 500 illustrating a spectral mask for a 20 MHz communication band. The spectral mask may be expressed as a set of lines applied to wireless transmissions. The horizontal portion of the spectral mask may be referred to as the passband 510. The lines adjacent to the passband (e.g., the mask skirt 520 and 530) are meant to attenuate signals ±10 MHz from the center frequency by a number of decibels in order to reduce adjacent channel interference (ACI). The power spectral density (PSD) of the transmitted signal should fall within the spectral mask. The PSD may be in units of dBr, which represents the dB relative to the maximum spectral density of the signal. The spectral mask may be used to measure a total out-of-band emission power, which may include orthogonal and non-orthogonal interferences. In FIG. 5, out-of-band emission power may refer to the emission power in the signal outside of the 20 MHz communication band (or beyond ±10 MHz from the central frequency of 0 MHz). The spectral mask may be used for controlling ACI to a non-synchronized receiver.

Previously, before OFDMA was introduced, the EVM requirement in the IEEE 802.11 specification was used to define the in-band self-interference level for acceptable single-user demodulation performance. The self-interference may refer to the interference from the wireless device itself (e.g., from the transmitter of the wireless device) before a signal enters a transmission channel. The interference may include distortions due to transmitter imperfection (e.g., from a power amplifier imperfection such as signal clipping from saturation). In OFDMA, however, the EVM definition may be expanded. For example, when a wireless device is assigned an RU for OFDMA transmission, the wireless device may measure in-band RU EVM, which is the EVM computed on the tones of the RU assigned to the wireless device. The wireless device may also measure the EVM computed on the tones outside of the assigned RU, assuming the desired signal for the tones outside of the assigned RU is 0.

Table 1 below provides simulation results on the amount of leakage, as a result of narrowband transmission, to other RUs when a STA transmits on a particular RU assigned to the STA. The simulation assumed a single RU transmission with random 64 QAM data and no data was transmitted on other tones (other tones set to 0). The simulation also assumed a 20 MHz communication bandwidth (or physical layer convergence procedure (PLCP) protocol data unit (PPDU)) with 2× oversampling. The simulation utilized a Rapp Power Amplifier (PA) model with P=3 (an indication of the linearity of the PA such as a knee-parameter) and an input power back-off (IBO) of 4 dB or 10 dB. The simulation provides results for in-band RU EVM, EVMs in RUs adjacent to the assigned RU, EVMs in alternative RUs (RUs that are the 2nd RUs away from the assigned RU), and an EVM over the entire bandwidth, which in this simulation is 20 MHz.

Referring to Table 1, the first column indicates the RU that was tested. With each transmission, the second column indicates the two input backoff options-4 dB and 10 dB. The third column indicates the in-band RU EVM for the particular RU being tested. The fourth column indicates the EVM for RUs adjacent to the in-band RU (e.g., RUs adjacent to a left side of the in-band RU and RUs adjacent to a right side of the in-band RU). The fifth column indicates the EVM for alternative RUs (e.g., alternative RUs adjacent to a left side of the in-band RU and alternative RUs adjacent to a right side of the in-band RU), where the alternative RUs are RUs that are 2nd RUs away from the in-band RU. The last column indicates the EVM on the 20 MHz communication bandwidth.

TABLE 1
TXEVM Simulation Results (in dB)

| | | RU | | | |
|---|---|---|---|---|---|
| | | in-band | EVM on | EVM on | EVM on |
| TXRU | IBO | EVM | adj. RU | alt. RU | 20 MHz |
| 5^{th} RU26 | 10 dB | −44 | Left: −48 | Left: −60 | −51 |
| | | | Right: −48 | Right: −61 | |
| | 4 dB | −23 | Left: −27 | Left: −43 | −30 |
| | | | Right −27 | Right: −42 | |
| 9^{th} RU26 | 10 dB | −43 | Left: −50 | Left: −70 | −52 |
| 1^{st} RU26 | | | Right: −48 | Right: −67 | |
| | 4 dB | −22 | Left: −28 | Left: −51 | −31 |
| | | | Right −28 | Right: N/A | |
| 2^{nd} RU52 | 10 dB | −44 | Left: −49 | Left: N/A | −48 |
| (center RU26 | | | Right: −59 | Right: −85 | |
| is in between | 4 dB | −22 | Left: −28 | Left: N/A | −27 |
| this RU52 | | | Right −28 | Right: −59 | |
| and adj. | | | | | |
| RU52 on its | | | | | |
| right) | | | | | |
| 1^{st} RU52 | 10 dB | −43 | Right: −49 | Right: −86 | −48 |
| | 4 dB | −22 | Right: −28 | Right: −59 | −28 |
| 1^{st} RU106 | 10 dB | −44 | Right: −54 | Right: N/A | −47 |
| (center RU26 | 4 dB | −22 | Right: −44 | Right: N/A | −25 |
| in between | | | | | |
| two RU106) | | | | | |
| RU242 | 10 dB | −44 | N/A | N/A | −47 |
| | 4 dB | −22 | N/A | N/A | −25 |

As shown in Table 1, the in-band RU EVM may be independent of the size of the RU. The in-band RU EVM is about 4-7 dB higher than the adjacent EVM of the adjacent RU and much higher than the EVM of the alternative RU. Further, as shown in Table 1, for a given RU size, in-band RU EVM and EVM on the entire bandwidth may have a fixed dB difference, which is proportional to the bandwidth ratio in dB. The bandwidth ratio may be determined based on Eq. 2:

$$BW ratio = \frac{PPDU BW}{RU BW} . \qquad ( 2 )$$

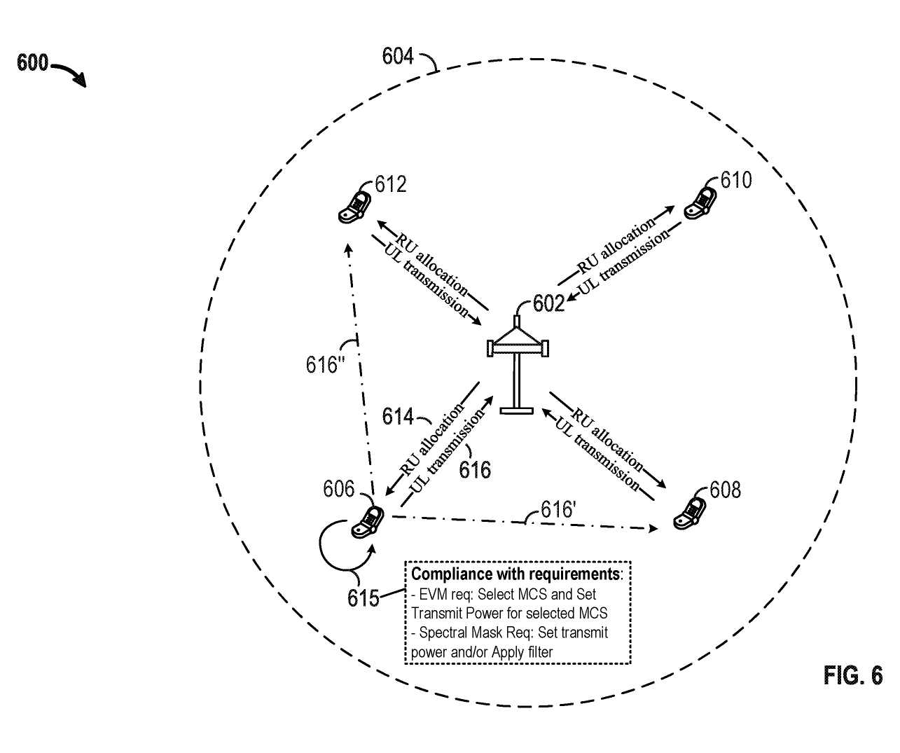

FIG. 6 is an exemplary diagram 600 of a method for UL OFDMA transmission. The diagram 600 illustrates an AP 602 broadcasting/transmitting within a service area 604. STAs 606, 608, 610, 612 are within the service area 604 of the AP 602 (although only four STAs are shown in FIG. 6, more or less STAs may be within the service area 604). To facilitate communication, the AP 602 may determine RUs that may be allocated to various wireless devices (e.g., the STAs 606, 608, 610, 612 and/or the AP 602). The AP 602 may determine the RUs by determining which communication bandwidth to use (e.g., 20 MHz, 40 MHz, 80 MHz, 160 MHz), based on which communication bandwidth(s) are available, and by determining a number of usable tones for the various RUs. In an aspect, the number of usable tones in a RU may be determined based on the amount of data to be transmitted (e.g., allocate RUs with more tones to accommodate larger data transmissions). In an aspect, the AP 602 may determine a total number of RUs based on a given communication bandwidth (or channel bandwidth) and a number of usable tones.

In an aspect, the AP 602 may determine to use the 20 MHz communication bandwidth and allocate 4 RUs with 52 usable tones (other communication bandwidths and/or RU sizes may also be selected). The AP 602 may allocate one RU to each of the STAs 606, 608, 610, 612. The AP 602 may transmit allocation information of the RU to each of the STAs 606, 608, 610, 612. For example, the AP 602 may transmit the allocation information to the STA 606 in a trigger frame 614 (or any other kind of frame such as a management frame or a control frame or message). The allocation information may indicate which RU(s) have been allocated to each of the STAs 606, 608, 610, 612 to enable the STAs 606, 608, 610, 612 to transmit data on the allocated RU (e.g., via UL OFDMA transmission). In an aspect, the allocation information may include one or more sets of tone indices that indicate when a RU begins and ends. The allocation information may include a communication bandwidth (e.g., 20 MHz, 40 MHz, 80 MHz, 160 MHz). The allocation information may include data symbol information such as information about which symbols have been allocated to the STAs 606, 608, 610, 612. In another aspect, the allocation information may include an index that identifies the RU allocated within a symbol to the respective STA.

Referring to FIG. 6, the STA 606, for example, may determine the RU allocated to the STA 606 by the AP 602 for OFDMA transmission. The STA 606 may determine the allocated RU by receiving the trigger frame 614 (or some other message) and by selecting the RU indicated in the trigger frame 614. In this example where four STAs 606, 608, 610, 612 are within the service area 604 of the AP 602, each of four 52-tone RUs (e.g., according to configuration 2 as shown in FIG. 3) may be allocated to a respective STA of the STAs 606, 608, 610, 612. Thus, for example, the STA 606 may be assigned the second 52-tone RU of 4 52-tone RUs in a 20 MHz bandwidth (e.g., according to configuration 2 as shown in FIG. 3). The STA 608 may be assigned the first 52-tone RU (e.g., starting from the left according to the configuration 2 shown in the second row 330 of FIG. 3), the STA 610 may be assigned the third 52-tone RU, and the STA 612 may be assigned the fourth 52-tone RU.

After the STA 606 determines the RU to which the STA 606 has been allocated, the STA 606 may transmit data on the allocated RU (e.g., via UL OFDMA transmission 616) based on requirements that limit the amount of inter-RU interference to other RUs assigned to other STAs. Specifically, the STA 606 may ensure that the transmission on the allocated RU may comply with certain EVM requirements and/or spectral mask requirements for OFDMA transmissions (at 615) so as not to cause an excessive amount of inter-RU interference (e.g., 616′, 616″) to the other STAs 608, 610, 612 that have been assigned adjacent and/or alternative RUs, and an excessive amount of adjacent channel interference to other systems. For example, before transmitting the data on the allocated RU, the STA may set transmit power for transmitting data and/or may apply a filter to transmission of the data, at 615, in order to comply with the EVM requirements and/or spectral mask requirements, as discussed more in detail infra.

Thus, according to various aspects of the disclosure, at least one of the following configurations may be implemented to define EVM requirements for OFDMA transmissions. Because inter-RU interference may depend on in-band RU EVM, limiting in-band RU EVM may indirectly control the levels of the EVM on the adjacent RU. A STA may be configured to satisfy the EVM requirements. For example, the STA 606 may be configured to set a transmit power to satisfy the EVM requirements, in order to minimize the levels of the EVM (e.g., 616′, 616″) on the adjacent RU. The STA 606 may set the transmit power by adjusting an output power of a transmitter amplifier of the STA 606 to satisfy the EVM requirements. Because the EVM requirements vary based on the MCS used for transmission, the STA 606 may set the transmit power based on the EVM requirements for the MCS used for transmission. The STA 606 may select the MCS used for transmission, e.g., based on a channel condition. In one example, the output power of the transmitter amplifier may be lowered by setting more backoff (e.g., thereby reducing the output power) to ensure that the power amplifier operates in a linear region of the power amplifier, rather than operating in a saturation region. Because a power amplifier operating in a saturation region is likely to cause out-of-band emission which causes interference (leakage) to neighboring RUs, the output power of the transmitter amplifier should be set such that the transmitter amplifier operates in a linear region. In an aspect, for transmission using a higher MCS, the STA 606 may apply a larger backoff for the transmitter amplifier to reduce the output power of the transmitter amplifier more because the EVM requirement for a higher MCS may be tighter (e.g., with a lower error threshold) than the EVM requirement for a lower MCS.

In a first configuration for EVM requirements, the STA 606 may be required to satisfy an in-band RU EVM requirement on the allocated RU (e.g., without considering portions of a bandwidth that do not correspond to the allocated RU). For in-band RU EVM (e.g., expressed as EVM_{in-band-RU}), the EVM is computed (e.g., see the discussion in relation to FIG. 4) on the tones of the allocated RU (e.g., RU allocated by the trigger frame 614). Table 2 below includes exemplary values of error thresholds (e.g., in-band RU EVM thresholds) for various MCSs. As such, if the STA 606 is required to comply with in-band RU EVM requirements and the STA 606 transmits on the allocated RU (e.g., via UL OFDMA transmission 616), then the transmission should not result in an in-band RU EVM value greater than an error threshold (e.g., allowed relative constellation error indicated in Table 2) for a corresponding MCS (e.g., MCS selected by the STA 606). The STA 606 may set the transmit power for the transmission of the data packet to ensure that the in-band RU EVM is not greater than the error threshold value for the corresponding MCS. The values in Table 2 are for illustrative purposes, and other values may be used. In some instances, for lower MCSs, the transmit power may be higher. The transmit power being higher for lower MCSs may be because for lower MCSs, transmitters may meet spectral mask requirements (discussed further below) and obtain acceptable demodulation performance with only a small backoff. This is especially true if the allocated RU is located far away from the band edge of the PPDU. The higher transmit power for lower MCSs may result in a high EVM and large interference to neighboring RUs. Accordingly, for lower MCSs, a tighter in-band RU EVM may be utilized (e.g., with error values/thresholds lower than those indicated in Table 2). Thus, for example, according an aspect of the EVM requirement, the in-band RU EVM for MCS 0, MCS 1, and MCS 2 may be 6 dB lower than the error values indicated in Table 2, and thus may be −11 dB, −16 dB, and −17 dB, respectively. In an aspect, low MCS performance may be spectral mask-limited instead of EVM-limited.

TABLE 2
Allowed Relative Constellation Error for in-band RU EVM

| MCS | | | Relative constellation |
|---|---|---|---|
| index | Modulation | Coding Rate | error (dB) |
| 0 | BPSK | 1/2 | −5 |
| 1 | QPSK | 1/2 | −10 |
| 2 | QPSK | 3/4 | −13 |
| 3 | 16-QAM | 1/2 | −16 |
| 4 | 16-QAM | 3/4 | −19 |
| 5 | 64-QAM | 2/3 | −22 |
| 6 | 64-QAM | 3/4 | −25 |
| 7 | 64-QAM | 5/6 | −27 |
| 8 | 256-QAM | 3/4 | −30 |
| 9 | 256-QAM | 5/6 | −32 |

In a second configuration for EVM requirements, the STA 606 may be required to satisfy an EVM requirement on the communication bandwidth (e.g., on the whole bandwidth). The EVM on the communication bandwidth may be measured (e.g., see the discussion in relation to FIG. 4) on the whole communication bandwidth having data on the allocated RU and zeros (e.g., zero data) inserted in the remaining tones (e.g., tones outside the allocated RU) of the communication bandwidth. Table 3 below includes exemplary error thresholds (e.g., threshold EVM values for various MCSs over a whole bandwidth. As such, if the STA 606 is required to comply with EVM requirement on the communication bandwidth and the STA 606 transmits the data packet on the allocated RU, the transmission should not result in an EVM value on the communication bandwidth greater than the error threshold value (e.g., allowed relative constellation error indicated in Table 3) for a corresponding MCS (e.g., MCS selected by the STA 606). The STA 606 may set the transmit power for the transmission of the data packet to ensure that the EVM value on the communication bandwidth is not greater than the error threshold value for the corresponding MCS. The values in Table 3 are for illustrative purposes, and other values may be used. For a given RU size, the EVM for the whole bandwidth may be estimated by subtracting a value based on a bandwidth ratio of the communication bandwidth (e.g., PPDU bandwidth) to an RU bandwidth of the allocated RU in dB from an in-band RU EVM of the allocated RU (e.g., as discussed above), which is shown below in Eq. 3:

$${EVM}_{Whole Bandwidth} = {EVM}_{in - band - RU} - 10 ⋆ {log}_{10} \frac{PPDU Bandwidth}{RU Bandwidth} . \qquad ( 3 )$$

TABLE 3
Allowed Relative Constellation Error for EVM over a whole bandwidth

| MCS | | | Relative constellation |
|---|---|---|---|
| index | Modulation | Coding Rate | error (dB) |
| 0 | BPSK | 1/2 | −5 |
| 1 | QPSK | 1/2 | −10 |
| 2 | QPSK | 3/4 | −13 |
| 3 | 16-QAM | 1/2 | −16 |
| 4 | 16-QAM | 3/4 | −19 |
| 5 | 64-QAM | 2/3 | −22 |
| 6 | 64-QAM | 3/4 | −25 |
| 7 | 64-QAM | 5/6 | −27 |
| 8 | 256-QAM | 3/4 | −30 |
| 9 | 256-QAM | 5/6 | −32 |

In an aspect of the second configuration, the EVM on the whole communication bandwidth may be normalized over a total transmit power of the transmitting RU (e.g., in-band RU allocated for transmission of data). In one example, an EVM over a whole bandwidth for a given RU with a size of NRU (e.g., size of the RU expressed as the number of tones in the RU) may be expressed as Eq. 4:

$${Error}_{RMS . RU} \sqrt{\frac{{\sum }_{{i}_{SC} = 1}^{{N}_{RU}} {\vert {Err}_{RU , {i}_{SC}} \vert}^{2} + {\sum }_{{i}_{SC} ∈ out of RU} {\vert {Err}_{O - RU , {i}_{SC}} \vert}^{2}}{{N}_{RU} ⋆ {P}_{0}}} . \qquad ( 4 )$$

Error_{RMS.RU} is an error over a whole bandwidth for a given RU, normalized based on a normalization factor (N_{RU}*P₀), Err_{RU,i}_{_{SC}} is an error within a transmitting RU (e.g., in-band RU allocated for transmission of data) and may be equal to a received symbol minus a transmitted symbol in the transmitting RU, i_{sc} is a tone index of the transmitting RU, and N_{RU} is a total number of tones per RU. Thus, Err_{RU,i}_{_{SC}} may be a collection of in-band error (e.g., in-band EVM). Err_{O-RU,i}_{_{SC}} is an error outside of the transmitting RU but still within the PPDU bandwidth with useful tones, where the transmitted symbol may be 0 (e.g., zero data). The transmission power for the tones outside of the transmitting RU are supposed to be zero because zeros (e.g., zero data) are inserted in the tones outside the transmitting RU. Thus, Err_{O-RU,i}_{_{SC}} may represent the leakage from the transmitting RU to neighboring RUs (e.g., out-of-band EVM). The normalization factor is N_{RU}*P₀, which represents a total transmit power of the transmitting RU. While the first configuration considers an error within the transmitting RU without considering an error outside the transmitting RU, the second configuration considers both the error within the transmitting RU and the error outside the transmitting RU and a total transmit power of the transmitting RU.

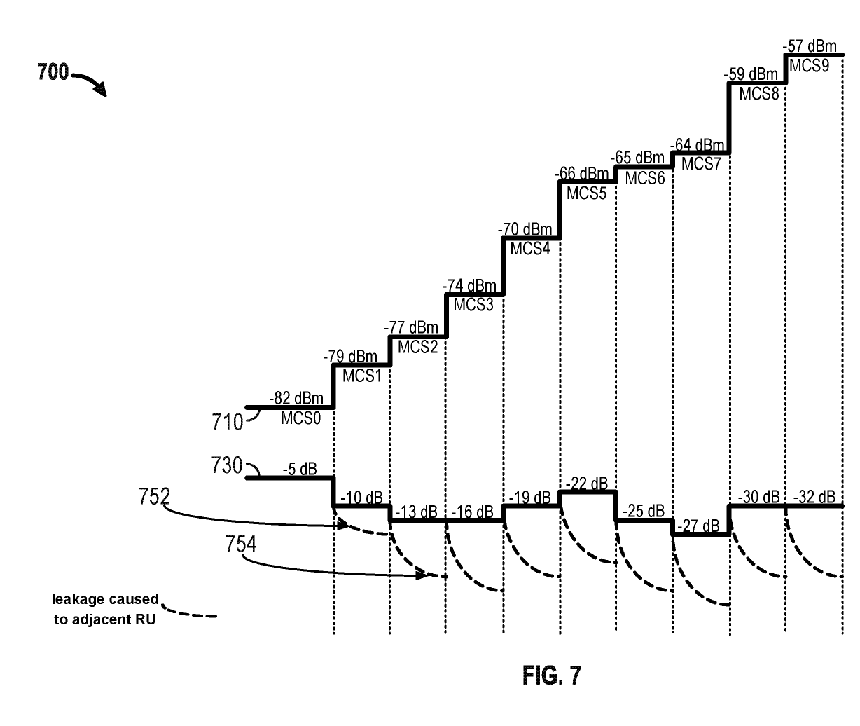

A minimum received power needed for a signal to be demodulated at a particular MCS may affect an in-band interference level based on an in-band EVM. FIG. 7 is a graph 700 that illustrates signal and interference levels with ideal power control. Referring to FIG. 7, the first staircase line (upper staircase line) 710 refers to the minimum power sensitivity per MCS, which is the minimum received power needed for a signal to be demodulated at a particular MCS. Thus, with the ideal power control, the minimum power sensitivity per MCS may match the first staircase line 710. The second staircase line (lower staircase line) 730 refers to an in-band interference level, which is the self-interference caused by the transmissions. The in-band interference level per MCS may be calculated by adding an in-band EVM to a minimum power sensitivity per MCS. Table 4 shows an example in-band interference level per MCS with the ideal power control, as illustrated in FIG. 7. For example, according to Table 4 and FIG. 7, the in-band interference level for MCS 0 is −82 dBm-5 dB=−87 dBm. The dashed lines in FIG. 7 represent the leakage to the neighboring resource unit (adjacent EVM or out-of-band EVM). For example, a first dashed line 752 represents a leakage or interference caused to an adjacent RU due to −87 dB in-band RU EVM at MCS 0. For example, a second dashed line 754 represents a leakage (or interference) caused to an adjacent RU due to −89 dB in-band RU EVM at MCS 1. With ideal power control, received signals are equal to the required signal-to-noise ratio (SNR) for a given MCS. With the ideal power control, the in-band interference level may be almost the same across different MCSs, as shown by the second staircase line 730 that is almost flat. As shown in FIG. 7 and Table 4, in-band interference levels range between −87 to −91 dBm. The leakage on adjacent RUs is 4-7 dB lower than the respective in-band interference. As shown in FIG. 7, all of the inter-RU interferences (e.g., caused by the leakage) are lower than the in-band interference levels.

TABLE 4
Example In-band Interference Level per MCS

| | | Relative | |
|---|---|---|---|
| | Minimum Power | constellation error | In-band |
| MCS | Sensitivity per MCS | (In-band RU EVM) | Interference Level |
| index | (dBm) | (dB) | (dBm) |
| 0 | −82 | −5 | −87 |
| 1 | −79 | −10 | −89 |
| 2 | −77 | −13 | −90 |
| 3 | −74 | −16 | −90 |
| 4 | −70 | −19 | −89 |
| 5 | −66 | −22 | −88 |
| 6 | −65 | −25 | −90 |
| 7 | −64 | −27 | −91 |
| 8 | −59 | −30 | −89 |
| 9 | −57 | −32 | −89 |

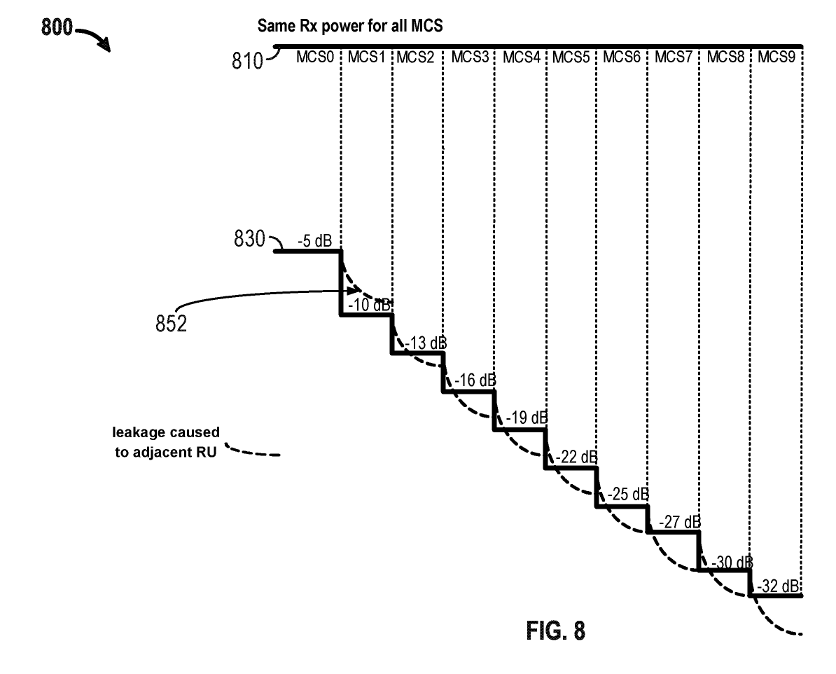

Unlike the example illustrated in FIG. 7 with the ideal power control, the EVM on adjacent RUs may be higher than in-band interference levels in practice, as illustrated in FIG. 8. FIG. 8 is a graph 800 that illustrates signal and interference levels when a power at the receiver is the same for all MCSs after power control (e.g., without the ideal power control). With practical power control and rate selection, the signal at the receiver may be stronger than that required by the particular MCS at which the signal is transmitted. For example, in an extreme case, the signal at the receiver may be power controlled such that the signal has the same power level 810 at the receiver for all MCSs as shown in FIG. 8. In an aspect, some products may have better sensitivities while others may have bad EVMs. As shown in FIG. 8, the dashed lines representing the leakage to the neighboring resource unit may be higher than the in-band interference level 830 in some cases. For example, a first dashed line 852 representing a leakage or interference caused to an adjacent RU due to in-band interference at MCS 0 is higher than the in-band interference level at MCS 1. In practice, leakage caused to an adjacent RU (adjacent EVMs) may be higher than in-band interference levels, which may lead to degraded performance in OFDMA transmission. To solve this issue, as discussed above, the in-band RU EVM requirement may be tightened for lower MCSs to give a greater margin for power control while ensuring acceptable OFDMA performance. In an aspect, the in-band RU EVM requirement for lower MCSs may be tightened (e.g., with error values/thresholds lower than those indicated in Table 2), such that the in-band interference level will become lower. For example, lowering an in-band RU EVM threshold for an MCS may reduce the in-band interference level and thus may reduce the leakage to a neighboring resource unit. In addition, in an aspect, STAs with large MCS and/or power differences may be separated by greater frequencies to allow any leakage to die down.

In a third configuration for EVM requirements, a used tone EVM (e.g., in-band EVM) and an unused tone EVM may be separately determined. The used tone EVM may be determined by dividing a sum of error values over the used tones (e.g., within a transmitting RU) by a number of used tones (e.g., transmitting tones). For example, to obtain a used tone EVM, a sum of error power values for tone indices −121 to −96 that represent the transmitting tones may be divided by 26, which is a number of transmitting tones. If the STA 606 is required to comply with the used tone EVM requirement and the STA 606 transmits the data packet on the allocated RU, the transmission should not result in an used tone EVM greater than an error threshold value (e.g., as discussed infra) for the used tone EVM requirement for a corresponding MCS (e.g., MCS selected by the STA 606). The STA 606 may set the transmit power for the transmission of the data packet to ensure that the used tone EVM is not greater than the error threshold for the corresponding MCS. The unused tone EVM may be determined by dividing a sum of error values over unused tones (e.g., outside the transmitting tones) by a number of unused tones, where the number of unused tones may be a difference of a total number of useful tones and a number of used tones (e.g., transmitting tones). For example, the unused tone EVM may be determined by calculating a sum of errors over unused tones corresponding to tone indices −75 to 121 (e.g., except for the DC tones) divided by a difference of a total number of usable tones (242) and a number of used tones (26). If the STA 606 is required to comply with the unused tone EVM requirement and the STA 606 transmits the data packet on the allocated RU, the transmission should not result in an unused tone EVM greater than an error threshold value (e.g., as discussed infra) for the unused tone EVM requirement for a corresponding MCS (e.g., MCS selected by the STA 606). The STA 606 may set the transmit power for the transmission of the data packet to ensure that the unused tone EVM is not greater than the error threshold value for the corresponding MCS.

In an aspect of the third configuration, the unused tones may be divided into several regions with different EVM requirements. For example, a region of unused tones close to the used tones may have a relaxed EVM requirement, while a region of unused tones distant from the used tones may have a tighter EVM requirement.

In an aspect of the third configuration, a used tone EVM requirement for a transmission over a whole bandwidth (full bandwidth transmission) may depend on whether dual carrier modulation (DCM), in which a first half the tones are in an RU used and the second half of the tones repeat data from the first half tones, is applied to an MCS. If the DCM is not applied to an MCS, error thresholds for the used tone EVM requirements may be based on error thresholds for the used tone EVM requirement for MCS values (e.g., MCS 0 through MCS 9). Thus, for example, error thresholds for the used tone EVM requirement for MCS 0 through MCS 9 without the DCM may be based on Table 3. On the other hand, if DCM is applied to MCS 0, MCS 1, MCS 3, and MCS 4, then error thresholds for the used tone EVM requirement for MCS 0, MCS 1, MCS 3, and MCS 4 with the DCM are respectively mapped to error thresholds for the used tone EVM requirement for the MCS 0, MCS 0, MCS 1 and MCS 2 without the DCM. In other words, for MCS 0 and MCS 1 with the DCM, the error threshold for the used tone EVM requirement of the MCS 0 without the DCM is used. The error threshold for the used tone EVM requirement for the MCS 1 without the DCM is used for the MCS 3 with the DCM, and the error threshold for the used tone EVM requirement for the MCS 2 without the DCM is used for the MCS 4 with the DCM. With the DCM, the same information is carried by two different subcarriers (e.g., a first set of subcarriers corresponding to the first half of an RU and a second set of subcarriers corresponding to the second half of the RU). In an aspect, with the DCM, the same information may be carried by two different subcarriers in different ways (e.g., with the first set of subcarriers carrying data with a phase rotation and the second set of subcarriers carrying data without a phase rotation).

For a full bandwidth transmission, for OFDMA cases, the EVM concept may be expanded to ensure the quality of OFDMA transmission such that the devices (e.g., STAs) sharing the same frequency may reduce interference with each other. The used tone requirement may be used to control maximum distortion level in the frequency domain for each transmitting RU. The unused tone requirement may be used to control a maximum interference level outside of the transmitting RU, but within the PPDU bandwidth. In an aspect, only a high efficiency (HE) modulation portion in a data frame may be controlled by the unused tone EVM requirement. The used and unused tone requirement may be used to limit EVM of triggered uplink packets and/or non-contiguous channel bonding, e.g., due to the spectrum being shared, a transmitter may only transmit on the unused portion of the PPDU bandwidth and limit leakage (e.g., EVM) in the portion occupied by others.

In an aspect of the third configuration, the used tone EVM requirement may be considered for the OFDMA transmission. The definition of used tone EVM is the same as the full bandwidth EVM except that the used tone EVM is computed for each transmitting RU separately. Thus, each transmitting RU should satisfy its own used tone EVM requirement. The used tone EVM requirement may depend on an MCS. Note that a single RU may be used in a triggered UL PPDU transmission, but multiple RUs may be used in a DL OFDMA transmission. In an aspect, to control the interference to RUs other than the transmitting RUs, the used tone EVM requirement for non-full bandwidth OFDMA transmission may be the same as the used tone EVM requirement (per MCS) in the full bandwidth EVM, as described above, except that error thresholds for the used tone EVM requirements of MCS 0 and MCS 1 for non-full bandwidth OFDMA transmission may be set to −13 dBc (decibels relative to the carrier), which is the same as error thresholds for used tone EVM requirement of MCS 2 for the full bandwidth OFDMA transmission (e.g., see Table 3), and that error thresholds for the used tone EVM requirement with the DCM may also be set to −13 dBc. The same EVM requirement for non-full bandwidth OFDMA transmission may be used for non-full bandwidth DL OFDMA to cover the future channel bonding. In another aspect, the used tone EVM requirement for trigger-based transmission (e.g., UL OFDMA transmission, UL MU MIMO transmission) may be the same as the used tone EVM requirement (per MCS) in the full bandwidth EVM, except that error thresholds for the used tone EVM requirements of MCS 0 and MCS 1 for the trigger-based transmission may be the same as the error threshold for the used tone EVM requirement of MCS 2 for the full bandwidth transmission.

In an aspect of the third configuration, the unused tone EVM requirement may be specified to account for the interference carried by unused tones in RUs other than a transmitting RU, e.g., in a triggered UL transmission. In such an aspect, the EVM of the unused tones (e.g., tones outside the transmitting RU) may be calculated by averaging per-tone EVM values of the unused tones. In particular, a per-tone EVM value of a tone outside the transmitting RU may be calculated by taking an error power of the tone outside the transmitting RU normalized to an average power per tone of the transmitting RU. The per-tone EVM values are averaged over frequency intervals (e.g., over a number of unused tones) to obtain the unused EVM. In an example, for the unused tone EVM, the per-tone EVM values may be averaged over 26 tones (per 2 MHz). In a PPDU bandwidth, certain intervals, e.g., last intervals may hold less tones. The unused tone EVM, obtained by taking the average power of the per-tone EVM values, may be equivalent to an EVM with respect to an origin constellation that is a constellation used in the transmit RU. Because the calculation of the unused tone EVM does not include normalization by an estimated channel, the unused tone EVM may be similar to a signal-to-noise ratio, and thus may be ˜3 dB lower than the used tone EVM. In an aspect, the unused tone EVM requirement may utilize one uniform unused tone EVM threshold for all the unused tones and independent of RU size may be preferred for simplicity. In an aspect, the unused tone EVM requirement may be set such that, per MCS, the unused tone EVM threshold is lower than the used tone EVM threshold by a few dB, which may be determined based on a frequency measured on the PPDU bandwidth. For example, the unused tone EVM threshold may be at approximately 2 dB below the used tone EVM threshold. In another example, the unused tone EVM threshold may be at approximately 10 dB below the used tone EVM threshold.

Local oscillator (LO) leakage may affect the EVM measurements. For a trigger-based PPDU, the LO leakage may affect the EVM measurements and thus may be excluded from the computation of the used tone EVM and the unused tone EVM. The limit may be −32 dBc, which for 52 tones is equal to −32+17=−15 dBr. The LO leakage may appear in one or more possible LO leakage locations. In one example, the LO leakage may appear in a center frequency of the PPDU tone plan and the +/−3 neighbor tones. In such an example, digital correction may be used for frequency precorrection for the trigger based PPDU. In another example, for a device operating in a 20 MHz bandwidth, the LO leakage may appear at a center of a 20 MHz primary channel of the PPDU tone plan and +/−3 tones, In another example, for a device operating in a 40 MHz bandwidth, the LO leakage may appear at a center of a 40 MHz primary channel of the PPDU tone plan and +/−3 tones. In another example, the LO leakage may appear outside of the PPDU bandwidth, where, for example, 80 MHz capable devices transmit 20 MHz or 40 MHz PPDUs. The LO leakage in this example may not affect the used tone EVM and the unused tone EVM.

If an exact LO leakage location is not known, a test device may search for the worst used tone EVM and/or the worst unused tone EVM in the possible LO leakage locations (e.g., described above), and treat the worst used tone EVM and/or the worst unused tone EVM as a potential LO leakage. The test device may exclude the tone corresponding to the worst used tone EVM and/or the worst unused tone EVM based on the used EVM measurement and/or unused tone EVM measurement. The test device may apply an LO leakage level requirement on the tone corresponding to the worst used tone EVM and/or the worst unused tone EVM.

EVM measurements may be sensitive to inter-carrier interference (ICI) due to timing error. Longer OFDM symbols (e.g., 4X) may allow bigger timing drift to develop. Higher MCSs require lower levels of an EVM, which may be more sensitive to timing errors. Thus, the timing error may be taken into consideration by using at least one of the following approaches. According to one approach, symbols in a PPDU may be derotated according to an estimated frequency offset, and the time drift may also be compensated. According to another approaches, the PPDU may be manipulated to account for both a frequency error and a timing drift error.

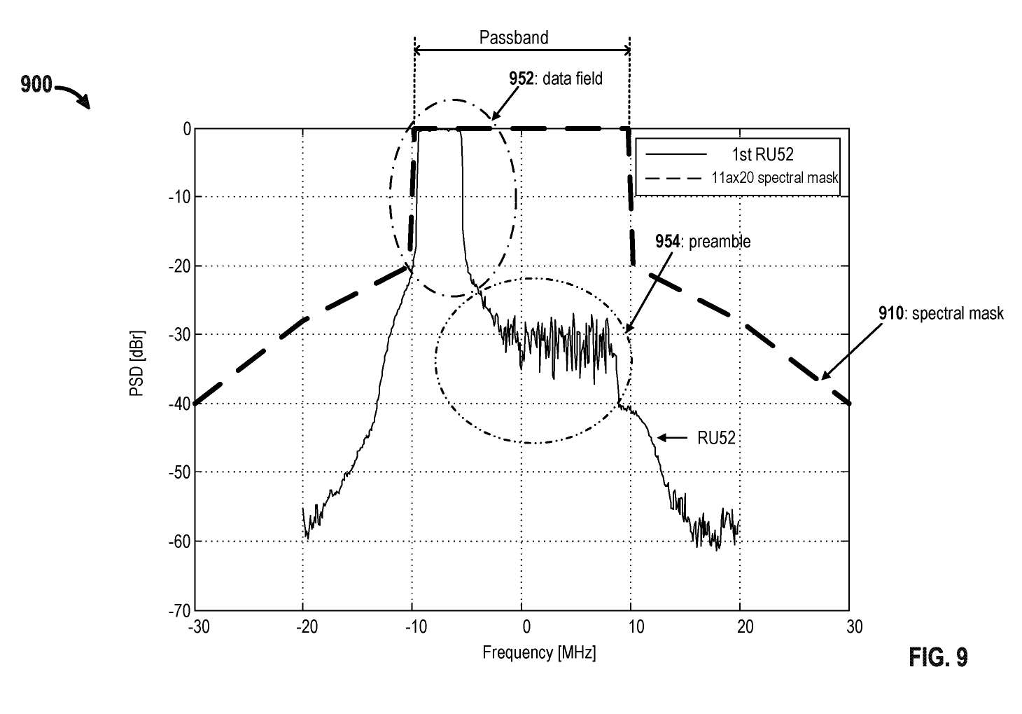

Some configurations according to an aspect of the disclosure may be related to defining a spectral mask, where the spectral mask may be used for controlling ACI to a non-synchronized receiver. Previously, before OFDMA was introduced, a spectral mask was defined to cover a whole bandwidth in order to limit ACI between different BSSs. In a first configuration for spectral mask requirements, in an OFDMA mode, the STA 606 may transmit a signal waveform compliant with spectral mask requirements. The spectral mask is implemented to limit out-of-band transmission to other devices. In an aspect of the first configuration for spectral mask requirements, the STA 606 may be required to transmit data packets that are bounded within a spectral mask associated with a communication bandwidth (e.g., a 20 MHz spectral mask). In this aspect, the data packet may include a preamble and a data field. To determine whether the data packet complies with the spectral mask, the data packet may be transmitted on the outer-most RU (e.g., left-most RU or right-most RU) to align the RU with the passband edge of the spectral mask. For example, FIG. 9 shows the data packet being transmitted on the outer-most RU. FIG. 9 is a graph 900 illustrating a data packet transmission within the boundaries of a 20 MHz spectral mask. In FIG. 9, the passband of the spectral mask 910 is located between −10 MHz and 10 MHz. As shown in FIG. 9, the data packet including a data field 952 and a preamble 954 is transmitted on a 52-tone RU (e.g., RU52), and is within the passband of the spectral mask 910. The data field 952 is aligned with a passband edge of the spectral mask 910. In FIG. 9, the data field 952 is aligned with a left passband edge of the spectral mask 910. Because preamble power is

$$10 ⋆ {log}_{10} \frac{Preamble BW}{RU BW}$$

lower than the power of the data field, the preamble 954 will already comply with the spectral mask.

In another aspect of the first configuration for spectral mask requirements, referring to FIG. 6, the STA 606 may be required to transmit a data field within a data packet (e.g., without transmitting any other field) such that the data field—not including the preamble—is bounded within the spectral mask of the communication bandwidth. Similar to the previous example, to determine whether the data field complies with the spectral mask, the data field may be transmitted on the outer-most RU to align the RU with a passband edge of the spectral mask. The result would be similar to FIG. 9, except without the preamble portion of the graph. A special test mode without a preamble is needed for this measurement.

In a second configuration for spectral mask requirements, the STA 606 may be required to transmit the data field within an RU-specific spectral mask. Because a single RU, as compared to a PPDU, has a narrower bandwidth, the narrow bandwidth of the RU-specific spectral mask may have a tighter mask skirt compared to that of a spectral mask for a communication bandwidth due to a lesser number of tones for multiplexing. A bandwidth of an RU-specific spectral mask may be wider than the bandwidth of the RU to allow for attenuation. Otherwise, the data would need to be transmitted with a large backoff and/or stringent filtering. In an aspect, even with RU-specific spectral masking, a spectral mask for the whole communication bandwidth may still be required because 242-tone RUs and 484-tone RUs may not be aligned with a 20 or 40 MHz in both bandwidth and boundaries.

In order to satisfy the spectral mask requirements, the STA 606 may be configured to adjust transmit power of the STA 606 and/or to apply a filter to a data packet transmitted from the STA 606. In an aspect, the STA 606 may set the transmit power of the STA 606 to minimize the leakage to a neighboring RU, thereby satisfying the spectral mask requirement to limit out-of-band transmission to other devices. The STA 606 may set the transmit power of the STA 606 by adjusting a output power of a transmit amplifier of the STA 606. The output power of the transmit amplifier may be adjusted such that a magnitude of the output power is away from a saturation region for the transmit amplifier. In another aspect, the STA 606 may be configured to apply a filter to a signal carrying the data packet transmitted from the STA 606, such that the filtered signal based on the filter satisfies the spectral mask requirement. For example, the filter may be a pulse-shaping filter with a passband similar to the passband of the spectral mask, which may pass a portion of the signal within the passband but may filter out a portion of the signal outside the passband.

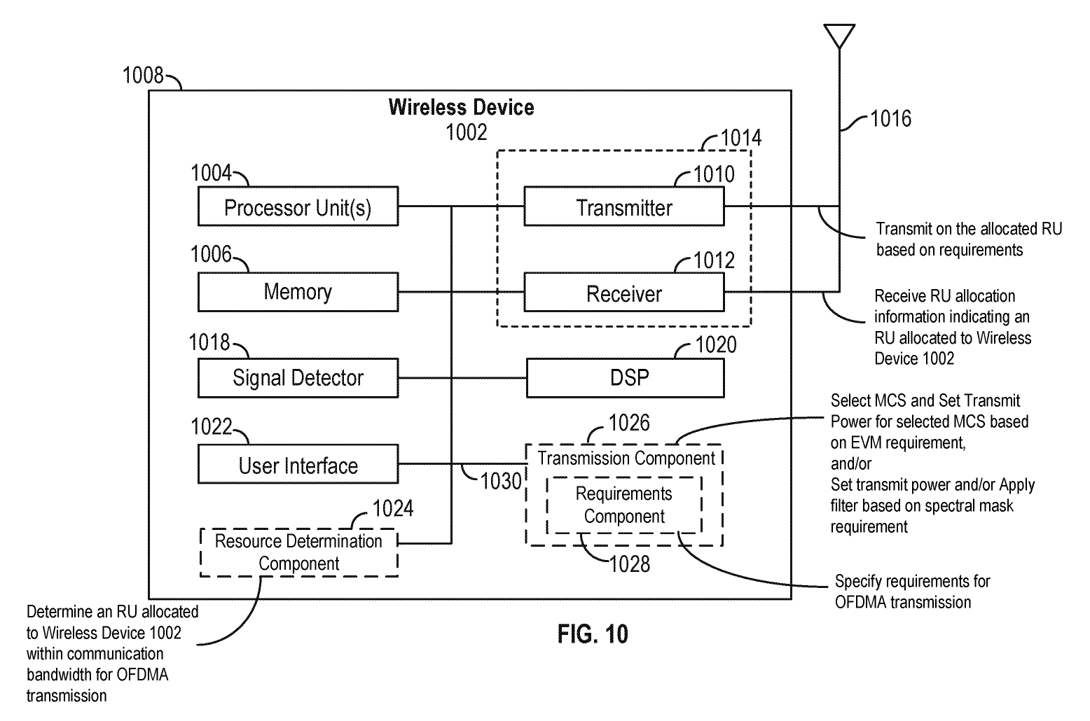

FIG. 10 is a functional block diagram of a wireless device 1002 that may be employed within the wireless communication system 100 of FIG. 1 for OFDMA transmission. The wireless device 1002 is an example of a device that may be configured to implement the various methods described herein. For example, the wireless device 1002 may comprise the STA 114, the STA 206, or the STA 606.

The wireless device 1002 may include a processor 1004 which controls operation of the wireless device 1002. The processor 1004 may also be referred to as a central processing unit (CPU). Memory 1006, which may include both read-only memory (ROM) and random access memory (RAM), may provide instructions and data to the processor 1004. A portion of the memory 1006 may also include non-volatile random access memory (NVRAM). The processor 1004 typically performs logical and arithmetic operations based on program instructions stored within the memory 1006. The instructions in the memory 1006 may be executable (by the processor 1004, for example) to implement the methods described herein.

The processor 1004 may comprise or be a component of a processing system implemented with one or more processors. The one or more processors may be implemented with any combination of general-purpose microprocessors, microcontrollers, digital signal processors (DSPs), field programmable gate array (FPGAs), programmable logic devices (PLDs), application specific integrated circuits (ASICs), controllers, state machines, gated logic, discrete hardware components, dedicated hardware finite state machines, or any other suitable entities that can perform calculations or other manipulations of information. In an aspect, the techniques, methods, etc., may be implemented in a modem processor, also referred to as a baseband processor.

The processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

The wireless device 1002 may also include a housing 1008, and the wireless device 1002 may include a transmitter 1010 and/or a receiver 1012 to allow transmission and reception of data between the wireless device 1002 and a remote device. The transmitter 1010 and the receiver 1012 may be combined into a transceiver 1014. An antenna 1016 may be attached to the housing 1008 and electrically coupled to the transceiver 1014. The wireless device 1002 may also include multiple transmitters, multiple receivers, multiple transceivers, and/or multiple antennas.

The wireless device 1002 may also include a signal detector 1018 that may be used to detect and quantify the level of signals received by the transceiver 1014 or the receiver 1012. The signal detector 1018 may detect such signals as total energy, energy per subcarrier per symbol, power spectral density, and other signals. The wireless device 1002 may also include a DSP 1020 for use in processing signals. The DSP 1020 may be configured to generate a packet for transmission. In some aspects, the packet may comprise a PPDU.

The wireless device 1002 may further comprise a user interface 1022 in some aspects. The user interface 1022 may comprise a keypad, a microphone, a speaker, and/or a display. The user interface 1022 may include any element or component that conveys information to a user of the wireless device 1002 and/or receives input from the user.

When the wireless device 1002 is implemented as a STA (e.g., the STA 114, the STA 206, the STA 606), the wireless device 1002 may also comprise a resource determination component 1024 and a transmission component 1026 including a requirements component 1028. The resource determination component 1024, the transmission component 1026, and/or the requirements component 1028 may be configured to perform the functions described herein. The resource determination component 1024 may be configured to receive from an AP, via the receiver 1012, RU allocation information indicating an RU allocated to the wireless device 1002 within a communication bandwidth for OFDMA transmission. The resource determination component 1024 may be configured to determine an RU allocated to the wireless device 1002 within a communication bandwidth for OFDMA transmission. In an aspect, the resource determination component 1024 may determine the allocated RU based on the RU allocation information. The transmission component 1026 may be configured to transmit, via the transmitter 1010, a data packet on the allocated RU based on requirements (e.g., specified by the requirements component 1028) associated with an amount of inter-RU interference to other RUs allocated to other wireless devices, the requirements including at least one of an EVM requirement or a spectral mask requirement. In an aspect, the transmission component 1026 may be configured to select an MCS to be used for the transmission on the allocated RU, and to set a transmit power for the transmission based on the EVM requirement on the allocated RU for the selected MCS, where the data packet is transmitted on the allocated RU using the set transmit power. In an aspect, the transmission component 1026 may be configured to perform at least one of: setting a transmit power for the transmission based on the spectral mask requirement, where the data packet is transmitted on the allocated RU using the set transmit power, or filtering a signal carrying the data packet with a filter based on at least one of the spectral mask requirement, where the data packet is transmitted on the allocated RU by transmitting the filtered signal.

The various components of the wireless device 1002 may be coupled together by a bus system 1030. The bus system 1030 may include a data bus, for example, as well as a power bus, a control signal bus, and a status signal bus in addition to the data bus. Components of the wireless device 1002 may be coupled together or accept or provide inputs to each other using some other mechanism.

Although a number of separate components are illustrated in FIG. 10, one or more of the components may be combined or commonly implemented. For example, the processor 1004 may be used to implement not only the functionality described above with respect to the processor 1004, but also to implement the functionality described above with respect to the signal detector 1018, the DSP 1020, the user interface 1022, the resource determination component 1024, the transmission component 1026, and/or the requirements component 1028. Further, each of the components illustrated in FIG. 10 may be implemented using a plurality of separate elements.

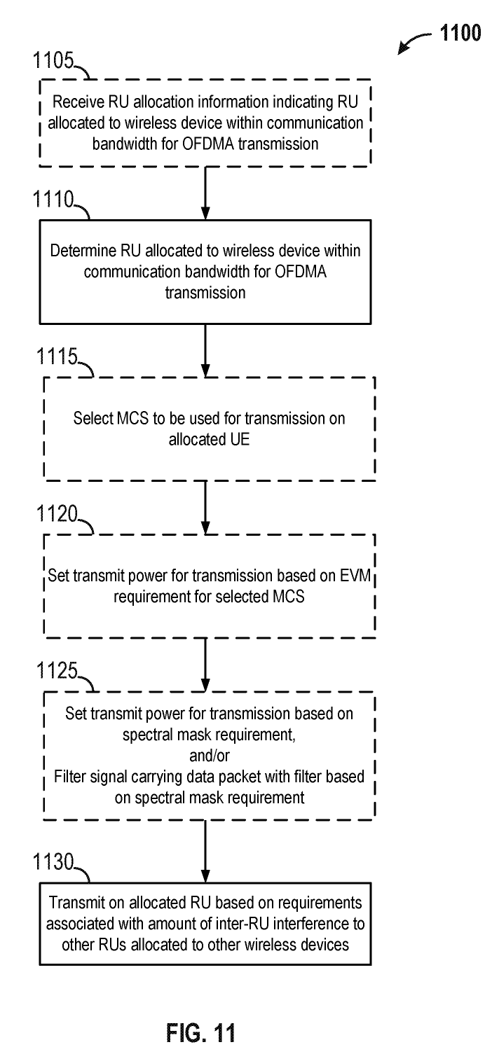

FIG. 11 is a flowchart of an exemplary method 1100 of OFDMA transmission.

The method 1100 may be performed using an apparatus (e.g., the STA 114, the STA 206, the STA 606, or the wireless device 1002, for example). Although the method 1100 is described below with respect to the elements of wireless device 1002 of FIG. 10, other components may be used to implement one or more of the steps described herein.

At block 1105, the apparatus may receive, from an AP, RU allocation information indicating an RU allocated to the apparatus within a communication bandwidth for OFDMA transmission. For example, as discussed supra, the STA 606 may receive allocation information from the AP 602, where the allocation information may indicate which RU(s) have been allocated to the STA 606 to enable the STA 606 to transmit data on the allocated RU (e.g., via UL OFDMA transmission).

At block 1110, the apparatus may determine an RU allocated to the apparatus within a communication bandwidth for OFDMA transmission. For example, as discussed supra, the STA 606 may determine the RU allocated to the STA 606 by the AP 602 for OFDMA transmission (e.g., based on the trigger frame 614 from the AP 602). In an aspect, the apparatus may determine the allocated RU based on the RU allocation information received from the AP.

At block 1115, in an aspect where the requirements include the EVM requirement, the apparatus may select an MCS to be used for the transmission on the allocated RU. For example, as discussed supra, the STA 606 may select the MCS used for transmission, e.g., based on a channel condition. At block 1120, the apparatus may a transmit power for the transmission based on the EVM requirement on the allocated RU for the selected MCS. The set transmit power may be used to transmit a data packet on the allocated RU. In an aspect, the transmit power may be set further based on past EVM measurements. In an aspect, the transmit power for the transmission may be adjusted by adjusting an output power of a transmit amplifier of the wireless device. For example, as discussed supra, the STA 606 may set the transmit power by adjusting an output power of a transmitter amplifier of the STA 606 to satisfy the EVM requirements. For example, as discussed supra, because the EVM requirements vary based on the MCS used for transmission, the STA 606 may set the transmit power based on the EVM requirements for the MCS used for transmission.

At block 1125, in an aspect where the requirements include the spectral mask requirement, the apparatus may perform at least one of: setting a transmit power for the transmission based on the spectral mask requirement, where a data packet may be transmitted on the allocated RU using the set transmit power, or filtering a signal carrying the data packet with a filter based on at least one of the spectral mask requirement, where a data packet may be transmitted on the allocated RU by transmitting the filtered signal. In an aspect, the filter may be a pulse-shaping filter having a passband that corresponds to a passband of a spectral mask of the spectral mask requirement. For example, as discussed supra, in an aspect, the STA 606 may adjust the transmit power of the STA 606 to minimize the leakage to a neighboring RU, thereby satisfying the spectral mask requirement to limit out-of-band transmission to other devices. For example, as discussed supra, in an aspect, the STA 606 may be configured to apply a filter to a signal carrying the data packet transmitted from the STA 606, such that the filtered signal based on the filter satisfies the spectral mask requirement.

At block 1130, the apparatus may transmit a data packet on the allocated RU based on requirements associated with an amount of inter-RU interference to other RUs. The requirements may include at least one of an EVM requirement or a spectral mask requirement. For example, as discussed supra, after the STA 606 determines the RU to which the STA 606 has been allocated, the STA 606 may transmit data on the allocated RU (e.g., via UL OFDMA transmission 616) based on requirements that limit the amount of inter-RU interference to other RUs assigned to other STAs. In an aspect, the amount of inter-RU interference is acceptable if a transmission on the allocated RU satisfies EVM and spectral mask requirements for uplink OFDMA. For example, as discussed supra, the transmission on the allocated RU may comply with certain EVM and spectral mask requirements for OFDMA transmissions so as not to cause an excessive amount of inter-RU interference.

In an aspect, the EVM requirement may include at least one of: an in-band EVM requirement on the allocated RU, or an EVM requirement on the communication bandwidth. For example, as discussed supra, the STA 606 may be required to satisfy an in-band RU EVM requirement on the allocated RU. For example, as discussed supra, the STA 606 may be required to satisfy an EVM requirement on the communication bandwidth.

In an aspect, the in-band EVM requirement on the allocated RU may be based on an MCS to be used for transmission. For example, as discussed supra, for lower MCSs, a tighter in-band RU EVM may be utilized (e.g., with error values/thresholds lower than those indicated in Table 2).

In an aspect, the transmit power may be set (e.g., at 1120) based on at least one of a first error threshold for the in-band EVM requirement or a second error threshold for the EVM requirement on the communication bandwidth, where the first error threshold and the second error threshold are based on the selected MCS (e.g., selected at 1115). In such an aspect, the transmit power may be set (e.g., at 1120) to provide at least one of an in-band EVM on the allocated RU being less than or equal to the first error threshold, or an EVM on the communication bandwidth being less than or equal to the second error threshold. For example, as discussed supra, if the STA 606 is required to comply with in-band RU EVM requirements and the STA 606 transmits on the allocated RU, then the transmission should not result in an in-band RU EVM value greater than an error threshold for a corresponding MCS (e.g., MCS selected by the STA 606). For example, as discussed supra, the STA 606 may set the transmit power for the transmission of the data packet to ensure that the in-band RU EVM is not greater than the error threshold value for the corresponding MCS. For example, as discussed supra, if the STA 606 is required to comply with EVM requirement on the communication bandwidth and the STA 606 transmits the data packet on the allocated RU, the transmission should not result in an EVM value on the communication bandwidth greater than the error threshold value (e.g., allowed relative constellation error indicated in Table 3) for a corresponding MCS (e.g., MCS selected by the STA 606). For example, as discussed supra, the STA 606 may set the transmit power for the transmission of the data packet to ensure that the EVM value on the communication bandwidth is not greater than the error threshold value for the corresponding MCS.

In an aspect, the EVM on the communication bandwidth may be based on the in-band EVM on the allocated RU, the communication bandwidth, and an RU bandwidth of the allocated RU, and the EVM on the communication bandwidth is determined further based on tones in the allocated RU having data, and based on remaining tones in the communication bandwidth having zero data. For example, as discussed supra, for a given RU size, the EVM for the whole bandwidth may be estimated by subtracting a value based on a bandwidth ratio of the communication bandwidth (e.g., PPDU bandwidth) to an RU bandwidth of the allocated RU in dB from an in-band RU EVM of the allocated RU. For example, as discussed supra, the EVM on the communication bandwidth may be measured on the whole communication bandwidth having data on the allocated RU and zeros (e.g., zero data) inserted in the remaining tones (e.g., tones outside the allocated RU) of the communication bandwidth. In such an aspect, the EVM on the communication bandwidth may be determined based on EVM normalization using a total transmit power of the allocated RU, and the EVM on the communication bandwidth may be determined further based on a combination of the in-band EVM and an out-of-band EVM of tones outside the allocated RU that is normalized by the total transmit power of the allocated RU. For example, as discussed supra, the EVM on the whole communication bandwidth may be normalized over a total transmit power of the transmitting RU, where the EVM on the whole communication bandwidth may be based on an error within a transmitting RU and an error from the leakage from the transmitting RU to neighboring RUs.

In an aspect, the EVM requirement may include at least one of: a used tone EVM requirement based on a used tone EVM, or an unused tone EVM requirement based on an unused tone EVM, where the used tone EVM is based on a first error measurement on used tones within the allocated RU and the unused tone EVM is based on a second error measurement on unused tones outside the allocated RU. For example, as discussed supra, for EVM requirements, a used tone EVM and an unused tone EVM may be separately determined, where the used tone EVM may be determined by dividing a sum of error values over the used tones by a number of used tones, and the unused tone EVM may be determined by dividing a sum of error values over unused tones by a difference of a total number of useful tones and a number of used tones.

In an aspect, the transmit power may be set (e.g., at 1120) based on at least one of a third error threshold for the used tone EVM requirement or a fourth error threshold for the unused tone EVM requirement, where the third error threshold and the fourth threshold may be based on the selected MCS (e.g., selected at 1115). In such an aspect, the transmit power may be set (e.g., at 1120) to provide at least one of the used tone EVM being less than or equal to the third error threshold, or the unused tone EVM being less than or equal to the fourth error threshold. For example, as discussed supra, if the STA 606 is required to comply with the used tone EVM requirement and the STA 606 transmits the data packet on the allocated RU, the transmission should not result in an used tone EVM greater than an error threshold value for the used tone EVM requirement for a corresponding MCS (e.g., MCS selected by the STA 606). For example, as discussed supra, the STA 606 may set the transmit power for the transmission of the data packet to ensure that the used tone EVM is not greater than the error threshold for the corresponding MCS. For example, as discussed supra, if the STA 606 is required to comply with the unused tone EVM requirement and the STA 606 transmits the data packet on the allocated RU, the transmission should not result in an unused tone EVM greater than an error threshold value for the unused tone EVM requirement for a corresponding MCS (e.g., MCS selected by the STA 606). For example, as discussed supra, the STA 606 may set the transmit power for the transmission of the data packet to ensure that the unused tone EVM is not greater than the error threshold value for the corresponding MCS.

In an aspect, error thresholds for the used tone EVM requirement for MCS 0, MCS 1, MCS 3, and MCS 4 with DCM may be respectively mapped to error thresholds for the used tone EVM requirement for the MCS 0, MCS 0, MCS 1, and MCS 2 without the DCM when the DCM is applied to an MCS, and error thresholds for the used tone EVM requirement may be based on error thresholds for the used tone EVM requirement for MCS 0 through MCS 9 without the DCM when the DCM is not applied to an MCS. For example, as discussed supra, if DCM is applied to MCS 0, MCS 1, MCS 3, and MCS 4, then error thresholds for the used tone EVM requirement for MCS 0, MCS 1, MCS 3, and MCS 4 with the DCM are respectively mapped to error thresholds for the used tone EVM requirement for the MCS 0, MCS 0, MCS 1 and MCS 2 without the DCM. For example, as discussed supra, if the DCM is not applied to an MCS, error thresholds for the used tone EVM requirements may be based on error thresholds for the used tone EVM requirement for MCS values (e.g., MCS 0 through MCS 9).

In an aspect, at least one of the used tone EVM or the unused tone EVM is determined without considering a tone with LO leakage, and a location of the tone with the LO leakage may be determined by searching for a worst tone among a plurality of possible LO leakage locations. For example, as discussed supra, for a trigger-based PPDU, the LO leakage may affect the EVM measurements and thus may be excluded from the computation of the used tone EVM and the unused tone EVM. For example, as discussed supra, if an exact LO leakage location is not known, a test device may search for the worst used tone EVM and/or the worst unused tone EVM in the possible LO leakage locations, and treat the worst used tone EVM and/or the worst unused tone EVM as a potential LO leakage.

In an aspect, for at least one of used tone EVM measurement or unused tone EVM measurement, symbols in a PDU is derotated according to an estimated frequency offset. In an aspect, for at least one of used tone EVM measurement or unused tone EVM measurement, a PDU is compensated for a frequency error and a timing drift error. For example, as discussed supra, the timing error that affects the EVM measurements may be taken into consideration by using at least one of the following approaches. According to one approach, symbols in a PPDU may be derotated according to an estimated frequency offset, and the time drift may also be compensated. According to another approaches, the PPDU may be manipulated to account for both a frequency error and a timing drift error.

In an aspect, the used tone EVM may be determined based on a total error over the used tones divided by a number of the used tones, and the unused tone EVM may be determined based on a total error over the unused tones divided by a number of the unused tones. For example, as discussed supra, used tone EVM may be determined by dividing a sum of error values over the used tones (e.g., within a transmitting RU) by a number of used tones (e.g., transmitting tones). For example, as discussed supra, the unused tone EVM may be determined by dividing a sum of error values over unused tones (e.g., outside the transmitting tones) by a number of unused tones, where the number of unused tones may be a difference of a total number of useful tones and a number of used tones (e.g., transmitting tones).

In an aspect, the used tone EVM requirement may be the same for a full bandwidth OFDMA transmission and a non-full bandwidth OFDMA transmission, except for error thresholds for used tone EVM requirement for MCS 0 and MCS 1 and error thresholds for used tone EVM requirement for an MCS with a DCM, and the error thresholds for the used tone EVM requirement for MCS 0 and MCS 1 for the non-full bandwidth OFDMA transmission may be the same as an error threshold for the used tone EVM requirement for MCS 2 for the full bandwidth OFDMA transmission. For example, as discussed supra, the used tone EVM requirement for non-full bandwidth OFDMA transmission may be the same as the used tone EVM requirement (per MCS) in the full bandwidth EVM, as described above, except that error thresholds for the used tone EVM requirements of MCS 0 and MCS 1 for non-full bandwidth OFDMA transmission may be set to −13 dBc, which is the same as error thresholds for used tone EVM requirement of MCS 2 for the full bandwidth OFDMA transmission (e.g., see Table 3), and that error thresholds for the used tone EVM requirement with the DCM may also be set to −13 dBc.

In an aspect, error thresholds for the used tone EVM requirement for MCS 0 and MCS 1 for a trigger-based transmission may be the same as an error threshold for the used tone EVM requirement for MCS 2 for a full bandwidth transmission. For example, as discussed supra, the used tone EVM requirement for trigger-based transmission may be the same as the used tone EVM requirement (per MCS) in the full bandwidth EVM, except that error thresholds for the used tone EVM requirements of MCS 0 and MCS 1 for the trigger-based transmission may be the same as the error threshold for the used tone EVM requirement of MCS 2 for the full bandwidth transmission.

In an aspect, the unused tone EVM is determined based on per-tone EVM values of the unused tones that are averaged over a number of the unused tones, each of the per-tone EVM values being calculated based on an error power of a corresponding unused tone normalized to an average power per tone of the allocated RU. For example, as discussed supra, a per-tone EVM value of a tone outside the transmitting RU may be calculated by taking an error power of the tone outside the transmitting RU normalized to an average power per tone of the transmitting RU. In an aspect, a threshold for the unused tone EVM requirement is below a threshold for the used tone EVM requirement. For example, as discussed supra, the unused tone EVM threshold may be at approximately 2 dB below the used tone EVM threshold.

In an aspect, an error threshold for the unused tone EVM requirement for each MCS may be below a threshold for the used tone EVM requirement for a corresponding MCS. For example, as discussed supra, the unused tone EVM requirement may be set such that, per MCS, the unused tone EVM threshold is lower than the used tone EVM threshold by a few dB.

In an aspect, the spectral mask requirement may include at least one of: a first requirement that a data packet transmission of the data packet is bounded within a spectral mask associated with the communication bandwidth, a second requirement that a data field transmission of the data packet is bounded within the spectral mask associated with the communication bandwidth, or a third requirement that the data field transmission of the data packet on the allocated RU is bounded within a second spectral mask of the allocated RU, where at least one of the transmit power or the filter may be set (e.g., at 1125) based on at least one of the first requirement, the second requirement, or the third requirement. For example, as discussed supra, the STA 606 may transmit a signal waveform compliant with spectral mask requirements. For example, as discussed supra, the data packet including a data field 952 and a preamble 954 may be within the passband of the spectral mask 910. For example, as discussed supra, the STA 606 may be required to transmit a data field within a data packet (e.g., without transmitting any other field) such that the data field—not including the preamble—is bounded within the spectral mask of the communication bandwidth. For example, as discussed supra, the STA 606 may be required to transmit the data field within an RU-specific spectral mask. For example, as discussed supra, the transmit power may be set by the STA 606 to ensure that the spectral mask requirement is satisfied, and/or the filter may be set to ensure that the spectral mask requirement is satisfied.

In an aspect, the data packet transmission satisfies the first requirement based on an output of a data field of the data packet on an outer-most RU that is aligned with a passband edge of the spectral mask associated with the communication bandwidth. For example, as discussed supra, to determine whether the data packet complies with the spectral mask, the data packet may be transmitted on the outer-most RU (e.g., left-most RU or right-most RU) to align the RU with the passband edge of the spectral mask. In an aspect, the data field transmission satisfies the second requirement based on an output of a data field of the data packet on an outer-most RU that is aligned with a passband edge of the spectral mask associated with the communication bandwidth. For example, as discussed supra, the data field 952 may be aligned with a passband edge of the spectral mask 910.

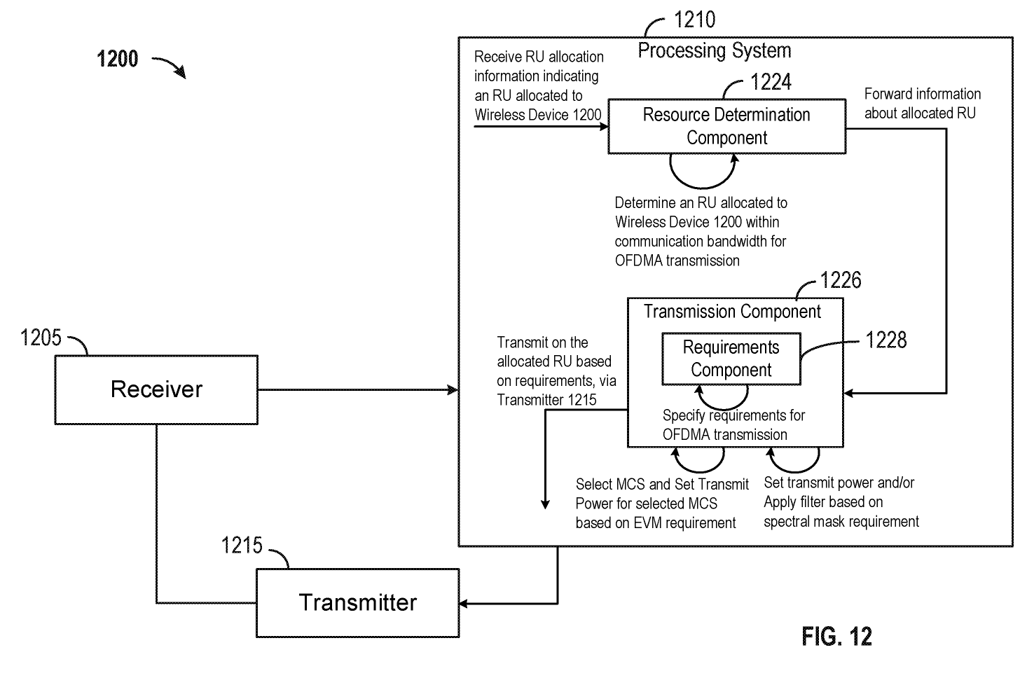

FIG. 12 is a functional block diagram of an exemplary wireless communication device 1200 for OFDMA transmission. The wireless communication device 1200 may include a receiver 1205, a processing system 1210, and a transmitter 1215. The processing system 1210 may include a resource determination component 1224 and a transmission component 1226 including a requirements component 1228. The receiver 1205, the processing system 1210, the transmitter 1215, the resource determination component 1224, the transmission component 1226, and/or the requirements component 1228 may be configured to perform the various function described herein. The resource determination component 1224 may be configured to receive from an AP, via the receiver 1205, RU allocation information indicating an RU allocated to the wireless communication device 1200 within a communication bandwidth for OFDMA transmission. The resource determination component 1224 may be configured to determine an RU allocated to the wireless communication device 1200 within a communication bandwidth for OFDMA transmission. In an aspect, the resource determination component 1224 may determine the allocated RU based on the RU allocation information. The transmission component 1226 may be configured to transmit, via the transmitter 1215, on the allocated RU based on requirements (e.g., specified by the requirements component 1228) associated with an amount of inter-RU interference to other RUs allocated to other wireless devices, the requirements including at least one of an EVM requirement or a spectral mask requirement. In an aspect, the transmission component 1226 may be configured to select an MCS to be used for the transmission on the allocated RU, and to set a transmit power for the transmission based on the EVM requirement on the allocated RU for the selected MCS, where the data packet is transmitted on the allocated RU using the set transmit power. In an aspect, the transmission component 1226 may be configured to perform at least one of: setting a transmit power for the transmission based on the spectral mask requirement, where the data packet is transmitted on the allocated RU using the set transmit power, or filtering a signal carrying the data packet with a filter based on at least one of the spectral mask requirement, where the data packet is transmitted on the allocated RU by transmitting the filtered signal.

The receiver 1205, the processing system 1210, the resource determination component 1224, the transmission component 1226, the requirements component 1228 and/or the transmitter 1215 may be configured to perform one or more functions discussed above with respect to blocks 1105, 1110, and 1115 of FIG. 11. The receiver 1205 may correspond to the receiver 1012. The processing system 1210 may correspond to the processor 1004. The transmitter 1215 may correspond to the transmitter 1010. The resource determination component 1224 may correspond to the resource determination component 124 and/or the resource determination component 1024. The transmission component 1226 may correspond to the transmission component 126 and/or the transmission component 1026. The requirements component 1228 may correspond to the requirements component 128 and/or the requirements component 1028.

Moreover, means for performing the various functions may include the receiver 1205, the transmitter 1215, the processing system 1210, the resource determination component 1224, the transmission component 1226, and/or the requirements component 1228.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, components and circuits described in connection with the present disclosure may be implemented or performed with a general purpose processor, a DSP, an ASIC, an FPGA or other PLD, discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, compact disc (CD) ROM (CD-ROM) or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes CD, laser disc, optical disc, digital versatile disc (DVD), floppy disk and Blu-ray disc where disks usually reproduce data magnetically, while discs reproduce data optically with lasers. Thus, computer readable medium comprises a non-transitory computer readable medium (e.g., tangible media).

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

Further, it should be appreciated that components and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a CD or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to aspects of the present disclosure, other and further aspects of the disclosure may be devised without departing from the basic scope thereof, and the scope thereof is determined by the claims that follow.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112(f), unless the element is expressly recited using the phrase “means for” or, in the case of a method claim, the element is recited using the phrase “step for.”

What is claimed is:

1. A method of wireless communication by a wireless device, comprising:
determining a resource unit (RU) allocated to the wireless device within a communication bandwidth for orthogonal frequency-division multiple access (OFDMA) transmission; and
transmitting a data packet on the allocated RU based on requirements associated with an amount of inter-RU interference to other RUs allocated to other wireless devices, the requirements including at least one of an error vector magnitude (EVM) requirement or a spectral mask requirement.

2. The method of claim 1, wherein the requirements include the EVM requirement, the method further comprising:
selecting a modulation and coding scheme (MCS) to be used for the transmission on the allocated RU; and
setting a transmit power for the transmission based on the EVM requirement on the allocated RU for the selected MCS,
wherein the data packet is transmitted on the allocated RU using the set transmit power.

3. The method of claim 2, wherein the transmit power is set further based on past EVM measurements.

4. The method of claim 2, wherein the EVM requirement comprises at least one of:
an in-band EVM requirement on the allocated RU; or
an EVM requirement on the communication bandwidth.

5. The method of claim 4, wherein the transmit power is set based on at least one of a first error threshold for the in-band EVM requirement or a second error threshold for the EVM requirement on the communication bandwidth, and
wherein the first error threshold and the second error threshold are based on the selected MCS.

6. The method of claim 5, wherein the transmit power is set to provide at least one of an in-band EVM on the allocated RU being less than or equal to the first error threshold, or an EVM on the communication bandwidth being less than or equal to the second error threshold.

7. The method of claim 6, wherein the EVM on the communication bandwidth is based on the in-band EVM on the allocated RU, the communication bandwidth, and an RU bandwidth of the allocated RU, and wherein the EVM on the communication bandwidth is determined further based on tones in the allocated RU having data, and based on remaining tones in the communication bandwidth having zero data.

8. The method of claim 7, wherein the EVM on the communication bandwidth is determined based on EVM normalization using a total transmit power of the allocated RU, and wherein the EVM on the communication bandwidth is determined further based on a combination of the in-band EVM and an out-of-band EVM of tones outside the allocated RU that is normalized by the total transmit power of the allocated RU.

9. The method of claim 2, wherein the EVM requirement comprises at least one of:
a used tone EVM requirement based on a used tone EVM, or
an unused tone EVM requirement based on an unused tone EVM,
wherein the used tone EVM is based on a first error measurement on used tones within the allocated RU and the unused tone EVM is based on a second error measurement on unused tones outside the allocated RU.

10. The method of claim 9, wherein the transmit power is set based on at least one of a third error threshold for the used tone EVM requirement or a fourth error threshold for the unused tone EVM requirement, and
wherein the third error threshold and the fourth threshold are based on the selected MCS.

11. The method of claim 10, wherein the transmit power is set to provide at least one of the used tone EVM being less than or equal to the third error threshold, or the unused tone EVM being less than or equal to the fourth error threshold.

12. The method of claim 10, wherein:
error thresholds for the used tone EVM requirement for MCS 0, MCS 1, MCS 3, and MCS 4 with dual carrier modulation (DCM) are respectively mapped to error thresholds for the used tone EVM requirement for the MCS 0, MCS 0, MCS 1, and MCS 2 without the DCM when the DCM is applied to an MCS, and
error thresholds for the used tone EVM requirement are based on error thresholds for the used tone EVM requirement for MCS 0 through MCS 9 without the DCM when the DCM is not applied to an MCS.

13. The method of claim 10, wherein at least one of the used tone EVM or the unused tone EVM is determined without considering a tone with local oscillator (LO) leakage, and wherein a location of the tone with the LO leakage is determined by searching for a worst tone among a plurality of possible LO leakage locations.

14. The method of claim 10, wherein, for at least one of used tone EVM measurement or unused tone EVM measurement, symbols in a protocol data unit (PDU) is derotated according to an estimated frequency offset.

15. The method of claim 10, wherein, for at least one of used tone EVM measurement or unused tone EVM measurement, a protocol data unit (PDU) is compensated for a frequency error and a timing drift error.

16. The method of claim 10, wherein the used tone EVM is determined based on a total error over the used tones divided by a number of the used tones, and
wherein the unused tone EVM is determined based on a total error over the unused tones divided by a number of the unused tones.

17. The method of claim 10, wherein the used tone EVM requirement is the same for a full bandwidth OFDMA transmission and a non-full bandwidth OFDMA transmission, except for error thresholds for used tone EVM requirement for MCS 0 and MCS 1 and error thresholds for used tone EVM requirement for an MCS with a dual carrier modulation (DCM), and
wherein the error thresholds for the used tone EVM requirement for MCS 0 and MCS 1 for the non-full bandwidth OFDMA transmission are the same as an error threshold for the used tone EVM requirement for MCS 2 for the full bandwidth OFDMA transmission.

18. The method of claim 10, wherein error thresholds for the used tone EVM requirement for MCS 0 and MCS 1 for a trigger-based transmission are the same as an error threshold for the used tone EVM requirement for MCS 2 for a full bandwidth transmission.

19. The method of claim 10, wherein the unused tone EVM is determined based on per-tone EVM values of the unused tones that are averaged over a number of the unused tones, each of the per-tone EVM values being calculated based on an error power of a corresponding unused tone normalized to an average power per tone of the allocated RU.

20. The method of claim 9, wherein an error threshold for the unused tone EVM requirement for each MCS is below a threshold for the used tone EVM requirement for a corresponding MCS.

21. The method of claim 1, wherein the requirements include the spectral mask requirement, the method further comprising:
setting a transmit power for the transmission based on the spectral mask requirement, wherein the data packet is transmitted on the allocated RU using the set transmit power, or
filtering a signal carrying the data packet with a filter based on at least one of the spectral mask requirement, wherein the data packet is transmitted on the allocated RU by transmitting the filtered signal.

22. The method of claim 21, wherein the filter is a pulse-shaping filter having a passband that corresponds to a passband of a spectral mask of the spectral mask requirement.

23. The method of claim 21, wherein the spectral mask requirement comprises at least one of:
a first requirement that a data packet transmission of the data packet is bounded within a spectral mask associated with the communication bandwidth;
a second requirement that a data field transmission of the data packet is bounded within the spectral mask associated with the communication bandwidth, or
a third requirement that the data field transmission of the data packet on the allocated RU is bounded within a second spectral mask of the allocated RU,
wherein at least one of the transmit power or the filter is set based on at least one of the first requirement, the second requirement, or the third requirement.

24. The method of claim 23, wherein the data packet transmission of the data packet satisfies the first requirement based on an output of a data field of the data packet on an outer-most RU that is aligned with a passband edge of the spectral mask associated with the communication bandwidth.

25. The method of claim 23, wherein the data field transmission of the data packet satisfies the second requirement based on an output of a data field of the data packet on an outer-most RU that is aligned with a passband edge of the spectral mask associated with the communication bandwidth.

26. A wireless device for wireless communication, comprising:
a memory; and
at least one processor coupled to the memory and configured to:
determine a resource unit (RU) allocated to the wireless device within a communication bandwidth for orthogonal frequency-division multiple access (OFDMA) transmission; and
transmit a data packet on the allocated RU based on requirements associated with an amount of inter-RU interference to other RUs allocated to other wireless devices, the requirements including at least one of an error vector magnitude (EVM) requirement or a spectral mask requirement.

27. The wireless device of claim 26, wherein the at least one processor is further configured to:
select a modulation and coding scheme (MCS) to be used for the transmission on the allocated RU;
set a transmit power for the transmission based on the EVM requirement on the allocated RU for the selected MCS,
wherein the data packet is transmitted on the allocated RU using the set transmit power.

28. The wireless device of claim 26, wherein the at least one processor is further configured to perform at least one of:
setting a transmit power for the transmission based on the spectral mask requirement, wherein the data packet is transmitted on the allocated RU using the set transmit power, or
filtering a signal carrying the data packet with a filter based on at least one of the spectral mask requirement, wherein the data packet is transmitted on the allocated RU by transmitting the filtered signal.

29. A wireless device for wireless communication, comprising:
means for determining a resource unit (RU) allocated to the wireless device within a communication bandwidth for orthogonal frequency-division multiple access (OFDMA) transmission; and
means for transmitting a data packet on the allocated RU based on requirements associated with an amount of inter-RU interference to other RUs allocated to other wireless devices, the requirements including at least one of an error vector magnitude (EVM) requirement or a spectral mask requirement.

30. A computer-readable medium of a wireless device storing computer-executable code, comprising code to:
determine a resource unit (RU) allocated to the wireless device within a communication bandwidth for orthogonal frequency-division multiple access (OFDMA) transmission; and
transmit a data packet on the allocated RU based on requirements associated with an amount of inter-RU interference to other RUs allocated to other wireless devices, the requirements including at least one of an error vector magnitude (EVM) requirement or a spectral mask requirement.
